(19) United States
(12) Patent Application Publication
(10) Pub. No.: US 2026/0084946 A1
(43) Pub. Date: Mar. 26, 2026

(54) Forklift Assembly

(71) Applicant: New Heights, LLC, Leola, PA (US)

(72) Inventors: Aaron Jay Beiler, Gap, PA (US); Raymond Beiler, New Holland, PA (US); Jeremiah Weaver, Narvon, PA (US); Josiah Harthcock, Lancaster, PA (US); William Fisher, Paradise, PA (US)

(73) Assignee: New Heights, LLC, Leola, PA (US)

(21) Appl. No.: 18/892,919

(22) Filed: Sep. 23, 2024

(51) Int. Cl. B66F 9/065; B60D 1/06; B60D 1/24; B60D 1/46; B66F 9/075

(52) U.S. Cl. CPC B66F 9/0655; B60D 1/06; B60D 1/246; B60D 1/46; B66F 9/07559; B66F 9/07572

(57) ABSTRACT

A forklift assembly is provided and generally includes a self-propelled frame having a pair of wheel assemblies, each providing a selectively driven wheel, the frame providing a carriage receiving assembly between the pair of wheel assemblies; an extension assembly having a first end and a second end, the first end of the extension assembly being pivotably connected to the frame; a control system; and a carriage assembly having a prong assembly, the carriage assembly being operably connected to the second end of the extension assembly and configured to be controllably positioned within the carriage receiving assembly. The wheel assembly having a selectively engageable drive system with a motor, a clutch assembly, a driveshaft having a first bearing surface and a second bearing surface and configured to be rotated by the motor, and a locking mechanism configured to selectively urge the driveshaft to shift in either a first direction or a second direction. The self-propelled frame having an articulating tow hitch; and at least one rear wheel assembly.

### CROSS-REFERENCE TO RELATED APPLICATION

This application is a continuation of U.S. patent application Ser. No. 18/312,953 filed on May 5, 2023, claiming the benefit of the filing date under 35 U.S.C. § 153.

### FIELD OF THE INVENTION

The present invention relates to a forklift assembly, and more particularly to a self-propelled forklift assembly with a selectively engaged driveline utilizing an urging clutch mechanism for safe engagement and disengagement of the driveline.

### BACKGROUND

In general, forklifts are often slow, heavy and difficult to control. Moreover, forklifts require an operator to be positioned on the forklift at all times in order to control the forklift's movement. However, an operator of a forklift is a dangerous profession, especially when a heavy load is leveraged by lifting above the forklift truck. The operator can lose control when on the forklift and either hurt themselves or the coworkers around them.

Additionally, because forklifts are often large and heavy machinery, traditional forklifts require heavy duty trailers to be transferred between job sites. Moreover, once the forklift is loaded for transport between job sited, it is often bulky and requires a lot of effort to secure it.

Further, forklifts tend to require a generally flat, planar surface in order to function properly because it lacks the ability to adjust to the terrain. Since the traditional forklift cannot adjust to the terrain, it is therefore obsolete and unable to perform tasks outside a level terrain. To alleviate this, forklifts that can handle rough terrain have been developed, such as telehandlers, through such vehicles still require large trailers and heavy equipment for transport between job sites.

Additionally, for vehicles that are to be towed by a tow vehicle, rather than loaded onto a trailer, there is a need to disengage the driveline in order to allow the towed vehicle to be towed without damage to the drivetrain. Any time that the driveline of a vehicle is disengaged, especially where the terrain is uneven, there is a risk of a runaway vehicle. Thus, there is a need for a driveline that can be selectively disengaged, such as for towing, but the disengagement may be delayed in becoming effective until such a time as conditions of the vehicle or stresses upon the driveline are appropriate for allowing the driveline to shift between engaged and disengaged states.

There is a need for an unmanned and remote control forklift, that is easily converted between a towing mode operation and an independent, self-propelled mode of operation, and has the ability to navigate uneven terrain, and have a selectively engageable drivetrain, that can be engaged for self-propelled operation, and disengaged for towed travel, but will only become disengaged when circumstances for the vehicle are appropriate for allowing freewheeling of the drive wheels.

As the foregoing illustrates, the invention provides the self-propelled forklift assembly, that can safely be converted between a self-propelled mode of operation with an engaged driveline, and a towed mode of operation with a disengaged driveline.

### SUMMARY

A forklift assembly is provided and generally includes a self-propelled frame having a pair of wheel assemblies, each providing a selectively driven wheel, the frame providing a carriage receiving assembly provided between the pair of wheel assemblies; an extension assembly having a first end and a second end, the first end of the extension assembly being pivotably connected to the frame; a control system; and a carriage assembly having a prong assembly, the carriage assembly being operably connected to the second end of the extension assembly and configured to be controllably positioned within the carriage receiving assembly. The forklift assembly may include a frame having a front support assembly and a rear support assembly. The front support assembly may provide a plurality of bracing plates positioned to form a rigid body, the bracing plates may include a wheel support plate extending forwards from the rigid body; at least one front wheel assembly supported by the wheel support plate, the at least one front wheel assembly having a selectively engageable drive system with a motor, a clutch assembly, a driveshaft having a first bearing surface and a second bearing surface and configured to be rotated by the motor, and a locking mechanism configured to selectively urge the driveshaft to shift in either a first direction or a second direction. The rear support assembly coupled to the front support assembly having: a rear support frame; an articulating tow hitch; and at least one rear wheel assembly. The rear support frame also provides an extension assembly coupled to the rear support assembly and a carriage assembly having a prong assembly.

In an exemplary embodiment, the extension assembly further may provide: a boom support; a sliding support positioned within the boom support; a sliding mechanism positioned within the sliding support; a raising mechanism coupled to an outer edge of the boom support.

In an exemplary embodiment, the carriage assembly further may have: a knuckle rotation assembly; a carriage movement assembly positioned within the knuckle rotation assembly; a back rest assembly coupled to the knuckle rotation assembly and the carriage movement assembly, wherein the prong assembly includes a pair of prongs secured to the backrest assembly, and protruding forwards therefrom.

In an exemplary embodiment, the front support assembly may further provide a top plate and a bottom plate, with the bracing plates positioned therebetween.

In an exemplary embodiment, the wheel support plate may be provided with a first portion and a second portion, the first portion may be perpendicularly positioned between the top plate and the bottom plate, and the second portion extending forwards from the first portion, and may not be positioned to reside in between the top plate and bottom plate, but rather may protrude forwards from them.

In an exemplary embodiment, the tow hitch may be pivotably secured to the rear support frame. In another embodiment, the rear support frame may provide a tow hitch actuator for pivotably moving the articulating tow hitch. In an embodiment, the rear support frame may further include a swing arm pivotably secured to the rear support frame and also pivotably secured to an extendible end of the tow hitch actuator. The tow hitch actuator may also be connected to the swing arm by a linkage arm, such that extension of the tow hitch actuator results in the tow hitch pivoting downwards, and retraction of the tow hitch actuator results in the tow hitch pivoting upwards.

In an exemplary embodiment, the forklift assembly may be provided a pair of front wheel assemblies, each supported by a respective wheel support plate.

In an exemplary embodiment, the locking mechanism may provide a pushing member and an urging member. The pushing member may be configured to travel within a housing and may be configured to reciprocate between a first position and a second position. The urging member may be in mechanical engagement with the pushing member, and the urging member may provide a collar with a plurality of radially oriented recesses, a plurality of plungers, and a plurality of biasing devices, with each recess of the plurality of recesses receiving one biasing device of the plurality of biasing devices, and one plunger of the plurality of plungers, such that the plurality of plungers may be oriented so as to be urged against a portion of the drive shaft.

In an exemplary embodiment, the driveshaft may be configured to be shifted laterally in a first direction in an amount for effecting engagement of the clutch assembly, and shifted laterally in a second direction in an amount for effecting the disengagement of the clutch assembly, the drive shaft further having an annular protrusion with the first bearing surface and the second bearing surface positioned on either side of an apex of the protrusion.

In an exemplary embodiment, the lateral shifting of the drive shaft can be urged in the first direction by the positioning of the urging member such that the plurality of plungers are pressed against the first bearing surface of the pair of bearing surfaces, and the lateral shifting of the drive shaft can be urged in the second direction by the positioning of the urging member such that the plurality of plungers are pressed against the second bearing surface of the pair of bearing surfaces.

In an exemplary embodiment, the clutch assembly may provide a driving clutch element mechanically fixed to the driveshaft, and a driven clutch element mechanically fixed to a wheel hub, the engagement of the clutch assembly is provided for powering the rotation of a wheel through the drive assembly by moving the driving clutch element into rotational interference with the driven clutch element.

In an exemplary embodiment, the drive system further may further include a motive power source, and the drive shaft may have a power input end that engages the motive power source through a connection allowing relative lateral movement, and an output end that is mechanically fixed to the driving clutch element. The urging of the drive shaft in the first direction by the urging member may not be effective in laterally shifting the driveshaft until such a point as the clutch assembly is capable of being engaged, for example, such as when the clutch assembly is in a position characterized by having the teeth of the driving clutch element and driven clutch element being rotated into non-overlapping alignment, when viewed in an axial direction. Conversely, the urging of the drive shaft in the second direction by the urging member may not be effective in laterally shifting the driveshaft until such a point as the clutch assembly is capable of being disengaged, for example, such as when the clutch assembly such as when the clutch assembly is in a position characterized by there being an absence of torque being transmitted through the clutch assembly of the driveline.

In an exemplary embodiment, the reciprocating movement of the pushing member may be directed by manipulating pressures in a first and second chamber alongside the pushing member, the pushing member having a medial seal that separates the first chamber from the second chamber.

In an exemplary embodiment, there is provided a forklift assembly with a self-propelled frame having: a pair of drive wheels; an articulating tow hitch assembly with a tow hitch having a ball hitch receiver at a first end, and pivotably secured to the frame at a second end, with an actuator and linkage assembly configured for urging the pivoting movement of the tow hitch upon actuation of the actuator; and a carriage assembly having a prong assembly, the carriage assembly mounted to an extension assembly configured to adjustably position the carriage assembly, and the carriage assembly and prong assembly configured to be positionable in a compact, stowed position characterized by the prongs being placed alongside the extension assembly and overlying and nearly parallel to a top surface of the frame.

In an exemplary embodiment, the linkage assembly provides a swing arm pivotably secured to the frame and also pivotably secured to an extendible end of the tow hitch actuator. The linkage assembly may also provide a linkage arm pivotably linking each of the swing arm and the second end of the tow hitch, such that extension of the tow hitch actuator will cause the first end of the tow hitch to be urged downwards relative to the frame, and retraction of the tow hitch actuator will cause the first end of the tow hitch to be urged upwards relative to the frame. In an embodiment, the linkage arm is a linear component, and the swing arm is a generally triangular component, with a pivoting mount to the frame at the top corner of the triangular swing arm, and the pivoting mount to each of the actuator and linkage arm are at the bottom of the triangle.

In an exemplary embodiment, there is provided a forklift assembly with a self-propelled frame having a pair of drive wheels at a front end, and a rear wheel assembly at a rear end, and a carriage receiving assembly positioned between the drive wheels; and a carriage assembly having a prong assembly, the carriage assembly positionable in the carriage receiving assembly such that the center of gravity of the of the forklift assembly, when the prong assembly is carrying a load, is maintained at a location between the drive wheels and the rear wheel assembly. In such an embodiment, the majority of the load is maintained within the footprint of the loaded forklift assembly.

In an exemplary embodiment, the method of transporting a forklift assembly would require at least the following steps:
a. providing a forklift assembly having a self-propelled frame with a pair of drive wheels and a carriage receiving assembly positioned therebetween; and a carriage assembly having a prong assembly at the end of an extension assembly pivotably mounted to the frame;
b. providing the extension assembly in a lowered and retracted configuration, and providing the carriage assembly urged into the carriage receiving assembly;
c. removing at least one linch pin from the carriage assembly;
d. rotating the prong assembly into a compact stowed configuration; and
e. securing the prong assembly in the compact stowed configuration by replacing the at least one linch pin in the carriage assembly.
   In an exemplary embodiment, the forklift assembly has an articulating tow hitch pivotably secured to the frame, and the method of transporting the forklift assembly may also require one or more of:
f. positioning the articulating tow hitch with a ball receiver mounted to a tow vehicle;
g. actuating an actuator of the articulating tow hitch to lower the ball receiver relative to the frame, and thereby raise a rear wheel assembly clear of the ground surface; and
h. disengage a drive assembly of the front wheel assemblies.
   In an exemplary embodiment, the method of transporting the forklift assembly may further require towing the forklift assembly with the tow vehicle.

In another exemplary embodiment, the method of propelling a self-propelled frame may require at least the following steps:
a. providing a forklift assembly having a self-propelled frame with a pair of drive wheels and a carriage receiving assembly positioned therebetween; and a carriage assembly having a prong assembly at the end of an extension assembly pivotably mounted to the frame, the prong assembly provided in a compact, stowed configuration;
b. providing the extension assembly in a lowered and retracted configuration, and providing the carriage assembly urged into the carriage receiving assembly;
c. removing at least one linch pin from the carriage assembly;
d. rotating the prong assembly out of the compact stowed configuration and into a deployed configuration.

In an exemplary embodiment, the forklift assembly has an articulating tow hitch pivotably secured to the frame, and the method of propelling a self-propelled frame may also require at least the following steps:
a. positioning the articulating tow hitch with a ball receiver mounted to a tow vehicle;
b. actuating an actuator of the articulating tow hitch to raise the ball receiver relative to the frame, and thereby lower a rear wheel assembly into weigh bearing configuration with the ground surface; and
c. engaging a drive assembly of the front wheel assemblies;
d. articulating the actuator of the articulating tow hitch to raise the ball receiver clear of the tow vehicle; and
e. controllable move the forklift assembly by operation of the drive assembly; and k. optionally reposition the carriage assembly by operation of the extension assembly.

### BRIEF DESCRIPTION OF DRAWINGS

In the following, the present invention is described in more detail with references to the drawings in which:

FIG. 1 illustrates a forklift assembly according to an exemplary embodiment of the invention;

FIG. 2 illustrates the forklift assembly of FIG. 1, with the top plate removed to reveal interior aspects of the front support assembly, according to an embodiment of the invention;

FIGS. 3 and 4 depict perspective views of the frame of the forklift assembly, with portions of the forklift assembly removed for clarity, according to an embodiment of the invention;

FIG. 5 depicts a left side view of the forklift assembly, according to an embodiment of the invention;

FIG. 6 illustrates a cross-sectional view of the forklift assembly of FIG. 5;

FIGS. 7-10 depict various perspective views of the forklift assembly of FIG. 1;

FIG. 11 depicts an outside perspective view of an embodiment of a front wheel assembly having selectively engageable drive system depicting the drive motor, and transmission, as well as an embodiment of the locking mechanism and hub assembly, of the on an exemplary embodiment of the forklift assembly;

FIG. 12 is a partially exploded view of the driveline components of the selectively engageable drive system of FIG. 11;

FIG. 13 is a partial cross-section view of the drive assembly for an exemplary embodiment of the forklift assembly, with the section view taken along the line 13-13 of FIG. 11;

FIG. 14 is an expanded top perspective view of the rear support assembly, according to an exemplary embodiment of the invention;

FIG. 15 is an expanded bottom perspective view of the rear support assembly, with the rear wheels removed for clarity, according to an exemplary embodiment of the invention;

FIG. 16 is an expanded right side perspective view of the rear support assembly, according to an exemplary embodiment of the invention;

FIG. 17 depicts the rear support assembly of FIG. 16, only with the outer plate having been removed for clarity, according to an exemplary embodiment of the invention;

FIG. 18 is a partially exploded view of components of an exemplary embodiment of the selectively engageable drive system and hub assembly, including driveshaft, clutch assembly, locking mechanism, and hub;

FIG. 19 is a partially exploded view of components of an embodiment of the selectively engageable drive system and hub assembly, including a bell housing with a locking mechanism, and hub;

FIG. 20 is a cross-section view of components of an embodiment of the selectively engageable drive system and the wheel hub assembly, according to an embodiment of the invention;

FIG. 21 is close up view of an embodiment of the clutch assembly, depicting the driving and driven clutch elements, according to an exemplary embodiment of the invention;

FIG. 22 is a cross-section view through the engaged clutch elements from FIG. 21, depicting the teeth of each of the driving clutch element against the teeth of the driven clutch element, taken along line 22-22 of FIG. 21;

FIG. 23 depicts a close up, cross-section view of an embodiment of the engaged clutch elements and driveshaft of an embodiment of the selectively engageable drive system, taken along line 23-23 of FIG. 22, according to an exemplary embodiment of the invention;

FIG. 24 depicts a close up, cross-section view of the disengaged clutch elements and driveshaft of FIG. 23;

FIG. 25 depicts a cross-section view of an embodiment of a manually controlled locking assembly and driveshaft an embodiment of the selectively engageable drive system and the wheel hub assembly, with the locking assembly provided in an unlocked configuration, according to an aspect of the invention;

FIG. 26 depicts a cross-section view of the manually controlled locking assembly and driveshaft of FIG. 25, only now provided in a locked configuration, according to an exemplary embodiment of the invention;

FIG. 27 is a partially exploded view of components of the manually controlled locking assembly of FIG. 25, according to an exemplary embodiment of the invention;

FIG. 28 is a cross-section view of the locking assembly of FIG. 25, taken through the plane along line 28-28, according to an exemplary embodiment of the invention;

FIG. 29 is a cross-section view of the locking assembly of FIG. 25, taken through the plane along line 29-29, according to an exemplary embodiment of the invention;

FIG. 30 is a cross-section view of the locking assembly of FIG. 25, taken through the plane along line 29-29, only with the driveshaft having been shifted to place the apex of the protrusion of the driveshaft in the depicted plane, according to an exemplary embodiment of the invention;

FIG. 31 depicts a cross-section view of an embodiment of a manually controlled locking assembly and driveshaft with the locking assembly in a locked configuration, and with the driveshaft urged to the left, but unable to shift due to interference of the clutch components, according to an exemplary embodiment of the invention;

FIG. 32 depicts a cross-section view of a manually controlled locking assembly and driveshaft with the locking assembly in a locked configuration, and with the driveshaft urged to the left, and having been shifted to engage the clutch assembly, according to an exemplary embodiment of the invention;

FIG. 33 depicts a cross-section view of a manually controlled locking assembly and driveshaft with the locking assembly in an unlocked configuration, and with the driveshaft urged to the right, but not shifting due to restraining force by the engaged clutch components, according to an exemplary embodiment of the invention;

FIG. 34 depicts a cross-section view of a manually controlled locking assembly and driveshaft with the locking assembly in an unlocked configuration, and with the driveshaft urged to the right, and having been shifted to disengage the clutch assembly, according to an exemplary embodiment of the invention;

FIG. 35 depicts a cross-section view of an embodiment of a pressure controlled locking assembly and driveshaft, with the locking assembly in an unlocked configuration, according to an exemplary embodiment of the invention;

FIG. 36 depicts a cross-section view of the pressure controlled locking assembly and driveshaft of FIG. 35, only now provided in a locked configuration, according to an exemplary embodiment of the invention;

FIG. 37 is a partially exploded view of components of the pressure controlled locking assembly, according to an exemplary embodiment of the invention;

FIG. 38 is a cross-section view of the locking assembly of FIG. 35, taken through the plane along line 38-38, according to an exemplary embodiment of the invention;

FIG. 39 illustrates a side perspective view of the carrier assembly and knuckle assembly for the forklift assembly, according to an exemplary embodiment of the invention;

FIG. 40 illustrates the carrier assembly and knuckle assembly of FIG. 39, only with portions of the carrier assembly and knuckle assembly removed for clarity;

FIG. 41 depicts an embodiment of the forklift assembly while being towed by a tow vehicle;

FIGS. 42-44 depict views of the isolated forklift assembly of FIG. 41;

FIGS. 45-47 depict views of a forklift assembly with an exemplary load being carried largely between the drive wheels;

FIG. 48 depicts a perspective view of a loaded forklift assembly, with an exemplary load being carried ahead of the drive wheels; and

FIGS. 49, 50 and 51 depict an embodiment of the forklift assembly being provided with deployable counterbalance arms in a stowed, and a deployed position.

### DETAILED DESCRIPTION OF THE EMBODIMENTS

With reference to the Figures, a forklift assembly 1 according to the invention is provided. In the exemplary embodiment, the forklift assembly 1 generally includes a frame 2, a drive assembly 4, an extension assembly 6, and a carrier assembly 8. Aspects of an exemplary embodiment of the invention will be described with reference to the figures. One skilled in the art would understand the depicted aspects are not the exclusive embodiment, and using the teachings of this application, variations of the invention may be provided and fall within the spirit of the invention.

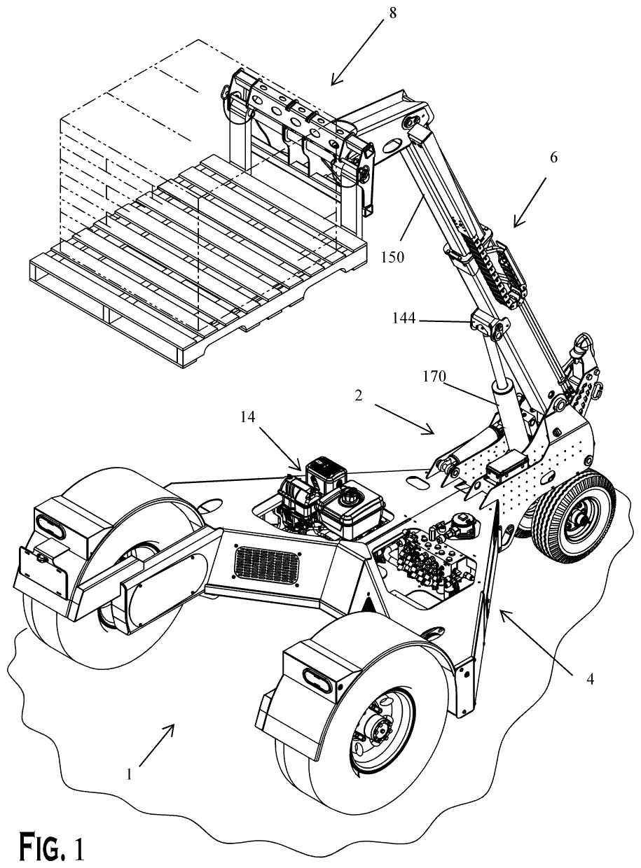

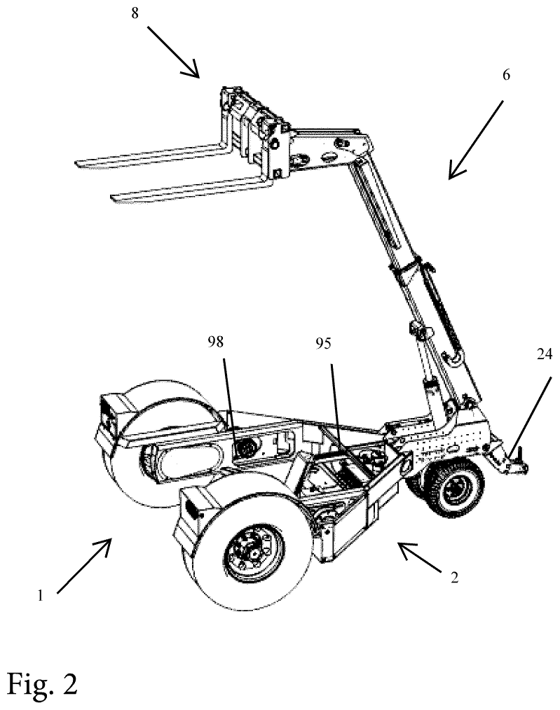

In the exemplary embodiment, the frame 2 generally has a front support assembly 10, and a rear support assembly 60. As used herein, the front of the forklift assembly 1 will be described as corresponding to the portion of the assembly 1 that corresponds to the direction that the forks are extended, as shown in FIG. 1, and the rear of the forklift assembly will be described as corresponding to the portion of the assembly 1 where a tow-hitch assembly is provided, as can be seen with reference to FIG. 2, and as will be described. It is recognized that the self-propelled movement of the forklift assembly may be reversible, and selectively operated in a forward direction, where the movement of the forklift assembly is in the same direction that the forks are oriented, or alternatively selectively operated in a rearward direction, characterized by the tow-hitch assembly being at the leading edge of the forklift assembly 1 when operated in reverse. The forklift assembly may be steered while in self-propelled operation, as will be discussed. It is the case then that when the forklift assembly 1 is to be towed behind a tow vehicle, as will be described, the forklift assembly will be towed with the rearmost end of the forklift assembly 1 secured to the tow vehicle.

The front support assembly 10, in an embodiment provides structural frame component having an internal cavity providing a receiving space 14. In an embodiment, the front support assembly is a three-dimensional frame, and may be any suitable shape, for example, a polygonal shape as shown. The front support assembly 10 provides support and secure mounting for a pair of forward extending front wheel assemblies and associated driveline components. The front support assembly 10 also provides support and secure mounting for the rearward extending rear support assembly 60. In an embodiment, the front support assembly, includes a plurality of beams and plates that are secured to each other to form a rigid body. Each of the beams and plates for forming a rigid structure may be mechanically secured to other components as described herein, and depicted in the figures, in any suitable manner. One of ordinary skill in the art would appreciate that “mechanically secured” may include any common mechanical securing methods, such as bolts, screws, or welding.

As shown in FIG. 1, in an embodiment, the front support assembly 10 includes at least a top plate 94, a bottom plate 96, and a plurality of bracing plates 95 positioned between the top and bottom plates. In an embodiment, the top and bottom plates 94, 96 are planar bodies having major planar surfaces, and minor edge surfaces forming the perimeter of each planar body. Each of the top and bottom plates are positioned to be generally horizontally oriented, and parallel to each, with the top plate positioned generally in vertical alignment with the bottom plate, such that the major planar surfaces of the top and bottom plates are provided in parallel planes. The top plate may be positioned generally above the bottom plate, spaced above by a distance. Spacing between the top and bottom plates is maintained by the bracing plates 95 arranged therebetween, as can be seen in FIG. 2, with the top plate 94 and portions of the forklift assembly 1 removed for clarity. The bracing plates 103 may be planar bodies or beams having major planar surfaces. The plurality of bracing plates may include at least a major crossmember 108, a pair of side bracing plates 102, and a pair of wheel support plates 98. Additionally, the front support assembly may provide one or more leading faces 106. Additional bracing may be provided by a rear crossmember 104, positioned between the ends of the side bracing plates 102, at the rear of the front support assembly 10. In an embodiment, a bracing plate is provided extended between the major crossmember 108 and the rear crossmember 104. The rear crossmember 104, and rear end portions of the side bracing plates 102 may receive or otherwise be secured to the rear support assembly 60, as will be discussed.

At least some of the bracing plates 95 of the front support assembly 10 may each be positioned so as to be generally perpendicular to the planar surface of the top and bottom plates and positions along a perimeter portion of each of the top and bottom plates, such as can be seen with reference to the side bracing plates 102 of FIG. 2. As shown in FIG. 1, one or more of the bracing plates 95, for example, the leading face plates 106, may be positioned with their major planar surface provided at an angle that is not necessarily perpendicular relative to the bottom plate; and may provide a sloped edge portion of the rigid hollow body of the front support assembly 10, where the respective edge portions of the top and bottom plate may not be in vertical alignment with each other. In the shown embodiment, the front support assembly is generally provided as a wedge shape, which angled side edges leading from the junction with the rear support assembly 60, and extending generally towards the front wheels 52. One skilled in the art will recognize that alternative vehicle designs are possible, and variations in supportive framing to withstand the expected loading from such a forklift assembly 1 can be provided in a multitude of alternative designs, including parallelogram, or other tube and/or beam frame assemblies. Thus, the depicted forklift assembly, provided in a wedge shape, is an exemplary embodiment, and it is contemplated that the teachings herein may be similarly applied for any suitable vehicle frame design for a forklift assembly.

In an embodiment, one or more of the bracing plates 95 may be positioned along and configured to join respective edge portions for each of the top and bottom plates 94, 96, such as can be seen with reference to the side brace plates 102, as well as the leading face plates 106. In an embodiment, one or more of the bracing plates 95 may be positioned where the bracing plate is not necessarily extending along the perimeter edge of the top and bottom plates, as can be seen with reference to the major cross member 108, where the major cross-member is positioned extending between a pair of points along opposite side edges of each of the top and bottom plates, with the planar body of the rear cross-member being positioned along a line extending through a mid-region of each of the top and bottom plates. One or more of the bracing plates 95 may be positioned so as to be generally perpendicular to each of the top plate and bottom plate. The pair of side bracing plates 102 are provided extending along the sides of the front support assembly 10 near the junction of the front support assembly 10 with the rear support assembly 60 and extending forwards to terminate generally behind the respective front wheel 52. The rear crossmember 104 and major crossmember 108 as shown are parallel to each other and are extended between the side brace plates 102. Positioned at or near each of the ends of the major crossmember 108, a pair of wheel support plates 98 are extended forwards to extend forwards from the rest of the front support assembly 10. In an embodiment, the side bracing plates terminate at the junction with the wheel support plate. A motor access plate 116 may be provided, continuing in line with the direction of the side bracing plate, but providing a removable access panel positioned between the top and bottom plate, to the outside of the wheel support plate, as depicted in FIGS. 2 and 4. The motor access plate 116, once removed as shown in FIG. 4 will allow access to components of the front wheel assembly 400, such as the motor 470, and or transmission 460, as will be discussed.

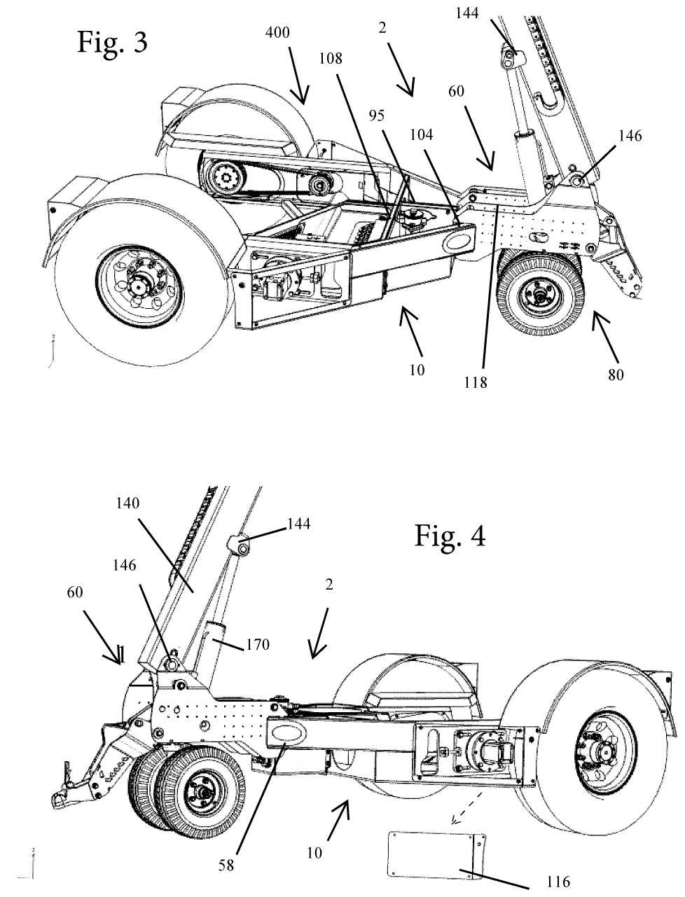

Each wheel support plate 98 may be a plate, or provided in the form of a hollow beam, where each wheel support plate is generally oriented to extend forwards from the side plates 100 parallel to the other wheel support plate 98, and each is configured to provide a rigid component to support the mounting of the front wheel 52 thereto, and also provide mounting for the components of the drive assembly for each wheel assembly 400, as will be discussed. Thus, the wheel support plate 98, provides a secure connection between the frame and the supported front wheel 52, in addition to providing for mounting of the drive assembly for that wheel. As shown in the exemplary embodiment depicted in FIG. 3, the wheel support plates 98 each provide a planar portion, such as a plate, or a generally planar hollow beam body, having at least one planar surface that is positioned between the top and bottom plates 94, 96, and extending forwards from the top and bottom plates. As shown, the wheel support plate may be a forward extending beam that is positioned vertically braced between the top and bottom support plates. As can be seen with reference to FIGS. 1 and 3, in an embodiment, at least a portion of the length of the wheel support plate 98 is positioned between the top plate 94 and bottom plate 96. In an embodiment, at least one half of the length of each wheel support plate 98 is provided being secured to either of the top or bottom plates, and with less than half of the length of the wheel support plate protruding as a cantilever ahead of the balance of the structure of the front support assembly 10. In an embodiment, the portion of the wheel support plate 98 extending forwards from the top and bottom plates may exceed the distance between the wheel hub center axis, and the end of the main structure of the front support assembly 10 (excluding the wheel support plate), as can be seen with reference to FIG. 1. The wheel support plates 98 are positioned so as to be parallel to each other, such that each of the front wheels 52, when properly mounted with their respective wheel hubs 410 rotatably secured to the wheel support plates 98, each of the wheels 52 will be able to roll parallel with each other by virtue of being in alignment with the other front wheel 52. Components of the drive assembly may be secured to the wheel support plates 98, and portions of the drive assembly may be hidden within the hollow beam interior of the wheel support plates, as can be seen with reference to FIG. 3, with portions of the forklift assembly removed for clarity. Details of the front wheel assemblies 400 and their respective drive assembly and operation thereof will be discussed below.

The front support assembly 10 may further provide a receiving space 14 within the interior of the structure, as illustrated in FIG. 1. Within the receiving space 14, various components for the operation of the forklift assembly may be provided. In an embodiment, the receiving space 14 may house the components required for the movement and steering control of the forklift assembly. For example, an onboard power source, such as an engine or motor, and/or battery or fuel storage, may be provided to power various actuators, for example an on-board hydraulic system, and to provide motive force for the movement of the forklift assembly 1. Additionally, a control system, for example a hydraulics manifold, may be housed within the receiving space 14 to facilitate power distribution for the controlled operation of various hydraulic actuators and/or motors, as will be discussed. Further, the receiving space 14 may house electronics that may be necessary for operation of the forklift assembly 1, such as the control system, which may include an onboard portion of a remote-control mechanism (e.g., receiver, processing unit, servos), and/or a processor to receive sensor information, process the information to determine the condition of the forklift assembly 1, as may be necessary, in order to allow user control or direction of onboard electronics and hydraulics for operation of the components of the forklift assembly 1, including drive and steering components, as well as operation of extension assembly 6 and carrier assembly 8, engagement, disengagement and actuation of the drive line for the front wheel assemblies 400. Additionally, the user, and/or the control system 112 may control the retraction and extension of the rear wheel assembly in an embodiment where the rear wheel assembly is configured to be retracted and extended, such as may be provided when shifting the forklift assembly between a self-propelled mode and a non-self-propelled mode for towing by a tow vehicle. Furthermore, in another embodiment, the user may selectively control the actuation mechanism for a deployable hitch, such that the forklift assembly 1 may be converted between the non-self-propelled mode of operation (tow behind) and a self-propelled mode of operation (as depicted in FIG. 1).

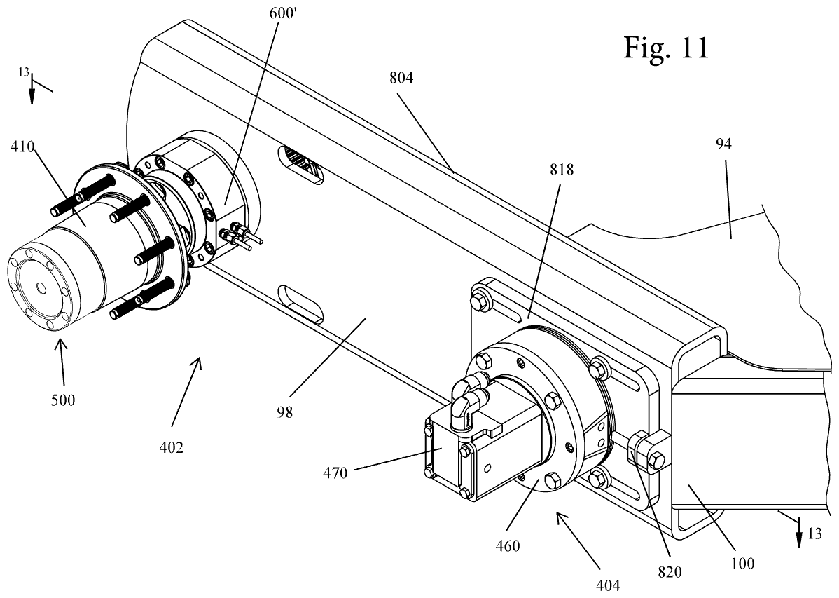

The front support assembly 10 further includes at least one front wheel assembly 400. As shown in the FIG. 4, with portions of the forklift assembly removed for clarity is the forklift assembly 1 is provided with a pair of front wheel assemblies, each having a front wheel 52. Each of the respective front wheel assemblies 400 is provided on one of the wheel support plates 98 of the front support assembly 10. Each front wheel assembly provides at least a motor 470 for controllably driving the rotation of each front wheel 52, a clutch assembly 500, and further includes an urging mechanism 600 for urging the selectively engagement or disengagement of a clutch assembly, as will be discussed. It is contemplated that the motor 470 that is used to drive the rotation of a wheel 52, may also be used to slow or prevent the rotation of the wheel, such as where the motor is a hydraulic motor, and uses resistance to rotation of the motor to slow or stop the wheel rotation. Additionally, each wheel assembly 400 may optionally include a braking assembly, for example, by providing a brake caliper acting upon a brake rotor configured to rotate with the wheel hub assembly, as will be familiar to one of ordinary skill in the art. Details and operation of the drive system, and exemplary deployments of the drive system in an embodiment will be discussed with reference to FIGS. 11-13 below.

In an exemplary embodiment, the rear support assembly 60 is securely affixed to, and extends rearwards from, the rear of the front support assembly 10, as shown in FIGS. 1-6. The rear support assembly 60 provides for the pivotable mounting of the rear wheel assembly as a caster wheel, the pivotable mounting of an articulating tow hitch, and further provides for the pivotable mounting of the extension assembly 6. Additionally, the rear support assembly provides a mounting point for an actuator configured to controllably pivot the extension assembly 6 about a pivot mount, and an actuator controllably positioning the articulating tow hitch 24. Each actuator includes an actuator which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure. Still further, the rear support assembly 60 may provide for the adjustable mounting of one or more sensors, such as a first sensor, which may be a position switch configured to detect if the rear wheel assembly 80 is weight bearing or not; and a second sensor, which may be a position switch configured to detect if the articulating tow hitch has been caused to pivot to a position above, or below a set point within the range of articulation of the tow hitch.

In an exemplary embodiment, the rear support assembly 60 provides a rear support frame having a plurality of vertically oriented plates 118 that extend rearwards from the front support assembly 10 and has at least one bracing member 288 positioned perpendicular to the vertically oriented plates. In this manner, the combination of multiple generally parallel plates, along with one or more reinforcement element positioned perpendicular to, and across the parallel plates, and thereby provides rectangular or 3-dimensional structural elements that collectively provide a rigid rear support assembly that can withstand the loads applied by one or more of the extension assembly 6, loads transmitted from the rear wheel assembly, and loads from the articulating tow hitch assembly, in addition to loads transmitted through the front support assembly 10, such as through the front wheels.

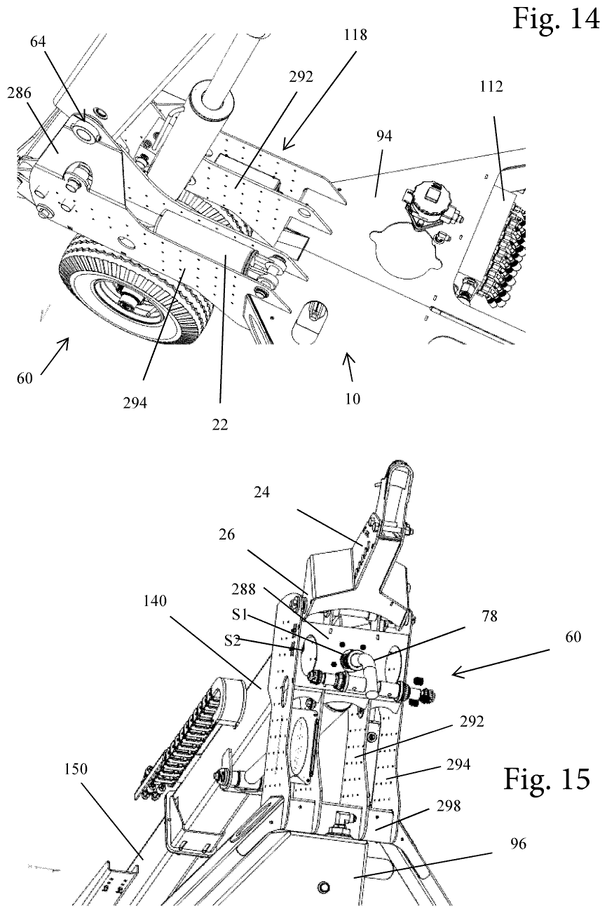

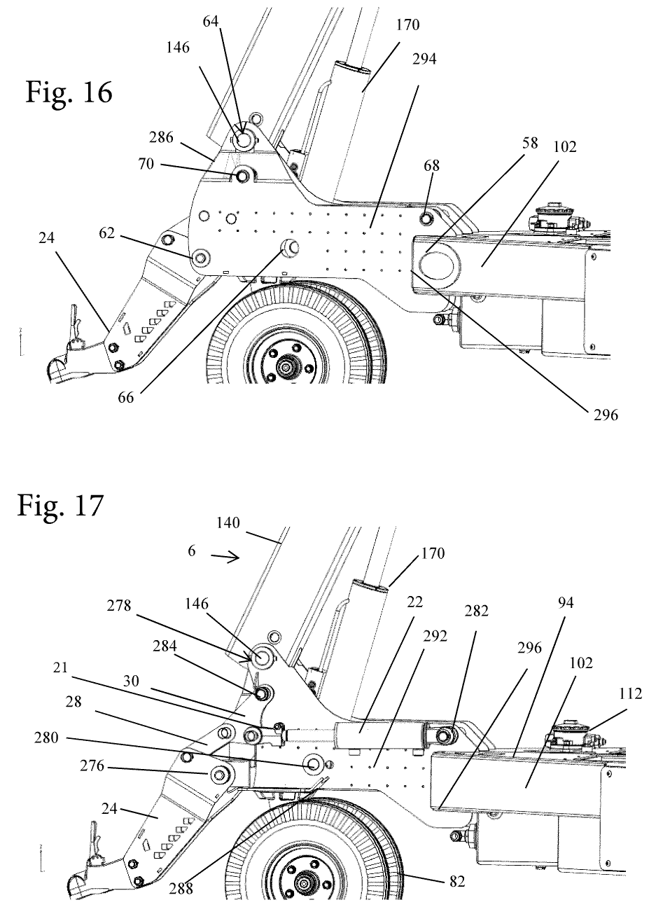

In an embodiment, the rear support assembly 60, as depicted in FIGS. 14-17 has a pair of inner support plates 292, and a pair of outer supports 294. FIG. 14 depicts an enlarged detail view of the rear support assembly 60, viewed from a top perspective. FIG. 15 depicts an enlarged detail view of the rear support assembly 60, viewed from a bottom perspective, with portions of the forklift assembly 1 removed for clarity. FIG. 16 depicts an enlarged detail view of the rear support assembly 60, viewed from a side perspective. FIG. 17 depicts the same view from FIG. 16, only with the outer support plate 294 removed for clarity. At a first end of all of the inner support plates 292 and the outer support plates 294, there are provided a rectangular groove or dado 296, such that each of the inner and outer plates can be fitted onto the front support assembly 10, with the rear crossmember 104 received with the dado of each plate 118. Each of the inner and outer plates may then be mechanically secured to the front support assembly 10 in any suitable manner. One of ordinary skill in the art would appreciate that “mechanically secured” may include any common mechanical securing methods, such as bolts, screws, or welding. The front support assembly 10 may further provide a shim brace element 298 that conforms to, and is mechanically secured to, the rearmost end portion of the front support assembly, to serve as a gusset, and to provide an improved junction between the front support assembly 10 and the rear support assembly 60. As shown, the shim brace element 298 is positioned against the front support assembly so that it will extend across a plurality of the plates 118 of the rear support assembly 60, fitting into the dado, and helps ensure a stiff connection that can transmit loads through the junction of the front support assembly 10 and the rear support assembly 60, with the loads borne across all of the inner plates 292 and outer plates 294 of the rear support assembly 60.

The inner support plates 292 are generally planar, having the dado 296 to allow securement to the front support assembly 10 at a first end, and having a plurality of through holes for mounting components of the forklift assembly thereto. With reference to FIG. 17, the inner support plates 292 provide a plurality of through holes to accommodate actuators and pivoting components of the forklift assembly. As shown in FIG. 17, the right, inner support plate 292 has at least five through holes. A first through hole 276 is provided at a second end of the inner support plate, opposite the first end, for pivotable mounting of the articulating tow hitch 24. A second through hole 278 is provided near the top of the inner support plate for pivotably mounting the extension assembly 6 thereto. A third through hole 280 is provided near the middle of the length of the inner support plate 292 that serves to pivotably mount an actuator of the raising mechanism, for the operation of the extension assembly 6. The inner support plate 292 further provides a fourth through hole 282 positioned near the dado 296 for mounting a fixed end of an actuator 22 for the articulating tow hitch to the inner plate 292. A fifth through hole 284 is provided at a point above the first through hole 276, the fifth through hole provided for the pivotable mounting of a swing arm 30 for the pivoting operation of the articulating tow hitch.

With reference to FIGS. 14 and 16, the outer support plates 294 have a planar portion that will be parallel to the plane of the inner plates 292. As shown, there are a pair of outer support plates 294 that are provided as generally symmetrical to each other, with each being located to the outside (away from the longitudinal center axis of the forklift assembly 1) of, and on opposite sides of, the pair of inner plates 292. The outer support plates 294 further provide a buttress portion 286 near the top of each outer plate, where a portion of the outer support plate is angled or bent inwards at an angle to provide a portion of the outer support plates that serves as brace or a buttress, with the top end aligned so as to rest against the outside surface of the respective inner plate 292. At the top of the buttress portion of the outer support plate 294 there is provided a through hole 64 that will align with the second through hole 278 of the inner plate, such that the extension assembly 6, when pivotably mounted by a fastener directed through the second through holes 278, will be supported collectively by each of the inner support plates 292 and outer support plates 294, with the buttressed portion of the outer support plates providing improved structural rigidity for the mounting of the extension assembly 6. Additionally, at the junction of the outer support plate to the side plate of the front support assembly, there is provided an angled projection portion 58 that is angled out of the plane of the vertically aligned portion of the outer support plate, such that the angled projection portion may align with, and rest against the side plate 100, such that the angled projection portion 58 can be mechanically secured against the side plate and thereby provide a strong connection between the front support assembly 10 and rear support assembly 60 when mechanically secured to each other.

The outer support plates 294 thus can be seen to provide a plurality of through holes, some of which may correspond to at least some of those present in the inner support plates. As shown, the outer plates 294 provide at least a first through hole 62, second through hole 64, third through hole 66, fourth through hole 68, and a fifth through hole 70. The third through hole 66 need not receive a fastener therethrough, but may provide an opening for access, such as for passing the fastener or a tool therethrough, for placing or adjusting the fastener through the third through hole 280 of the inner plates 292 that is provided to secure the lifting actuator of the raising mechanism 170 for the extension assembly 6, as will be discussed.

As shown in FIGS. 14-17, the articulating tow hitch 24 is pivotably secured by a fastener directed through first through hole 276 of the inner plates 292 and through first through hole 62 of the outer plates 294, as the fastener passes through all of the plates 118. The extension assembly 6 is pivotably mounted by a fastener, such as a yoke pin, directed through the second through hole 278 of the inner plates 292, and through second through hole 64 of the outer plates 294, which is located atop the buttress portion 286 of the outer plates 294, such that the fastener for the extension assembly 6 is passing through all of the plates 118. The actuator 22 for the operation of the articulating tow hitch 24 is pivotably secured by a fastener directed through the fourth through hole 282 of right side inner plate 292, and also the fourth through hole 68 of the right side outer plate 294. The swing arm 30 for pivoting the tow hitch 24 is pivotably secured by a fastener directed through the fifth through hole 284 of the right side inner plate, as well as through the fifth through hole 70 of the right side outer plate 294. Each of the fasteners for the through fixed end of the actuator 22 is directed through through holes 282, and the pivotable mount of the swing arm 30 directed through through hole 284 need only pass through one inner plate 292, and the adjacent outer plate 294, which as shown in FIG. 14 corresponds to the right side inner and outer plates.

As illustrated in FIGS. 15 and 17, the rear support assembly 60 provides at least one bracing member 288. In an embodiment, a bracing member 288 may be provided as a generally planar plate affixed across a bottom portion of the rear support assembly, with the bracing member 288 mechanically secured to each of the plates 118. The bracing member 288 may further provide an upright portion having receiving slots, such that each of the plates 118 are received within one of the receiving slots, and a portion of the upright of the bracing member is fitted perpendicularly between each plate 118. Additional bracing members 288 may be similarly fitted between each of the plates 118, where the bracing is provided generally perpendicular to the planar surface of the plates 118, and each bracing member 288 is in contact with at least two of the plates 118. Each bracing member 288 may be mechanically secured to the respective plates 118, to provide structural rigidity to the rear support assembly 60, such that the frame will be able to withstand the loading from articulation of the extension assembly 6, as well as loads applied to the frame from the wheels, as the forklift assembly 1 traverses varying terrain.

As illustrated in FIGS. 14-17, the rear support assembly 60 further includes a rear wheel assembly 80 having at least one rear wheel 82. The rear wheel assembly 80 as shown includes a pair rear wheels 82 positioned adjacent to each other on an axle at the end of a stem 78. In an exemplary embodiment, the rear wheel assembly 80 is provided as a two-wheeled swivel caster, though it is contemplated that a single wheel arrangement, which may optionally be steerable, could be substituted. In the exemplary embodiment, the rear wheel assembly 80 provides a pivoting stem 78 that is pivotably secured to the rear support assembly 60, such that the stem 78 may rotate about its longitudinal axis, relative to the rear support assembly 60. The rear wheel assembly 80 may be rotatably mounted to the rear support assembly 60, such that the rear wheel assembly 80 may be caused to pivot with the movement of the forklift assembly 1 while being self-propelled and/or steered. To provide for predictable and safe caster operation, the post may include a bend near the bottom of the stem 78 to allow for an amount of positive caster, where the contact patch of the rear wheel is offset somewhat from the steering axis extending through the longitudinal axis of the top portion of the stem 78. In such an instance, controlled movement and steering of the forklift assembly 1 may be achieved by operating the drive train of one or both of the front wheel assemblies 400, as will be discussed. In this manner, where the drivetrains of the front wheel assemblies 400 are operated independently or at different rates, this will provide directional steering control to the forklift assembly 1 while operating in the self-propelled mode. Similarly, when the drivetrains of the respective front wheel assemblies 400 are operated at the same rates, and the drive forces are synchronized together, movement of the forklift generally will be linearly forwards or backwards. Steering adjustments while in self-propelled mode can be made by altering the rate and/or drive direction of the drive motor 470 of one driven front wheel 52, relative to the other front wheel 52, thereby creating a yaw action that will rotate the forklift assembly 1 as the rear wheel operates in caster fashion.

As shown in FIGS. 4 and 11-13, each of the front wheel assemblies 400 provides a selectively engageable drive assembly 402. Each of the front wheel assemblies 400 may independently be powered by the drive motor 470 to drive the forklift assembly 1 when operated in a self-powered mode. Additionally, the selectively engageable drive assembly 402 may be disengaged, as will be explained, to allow operation as a towed vehicle.

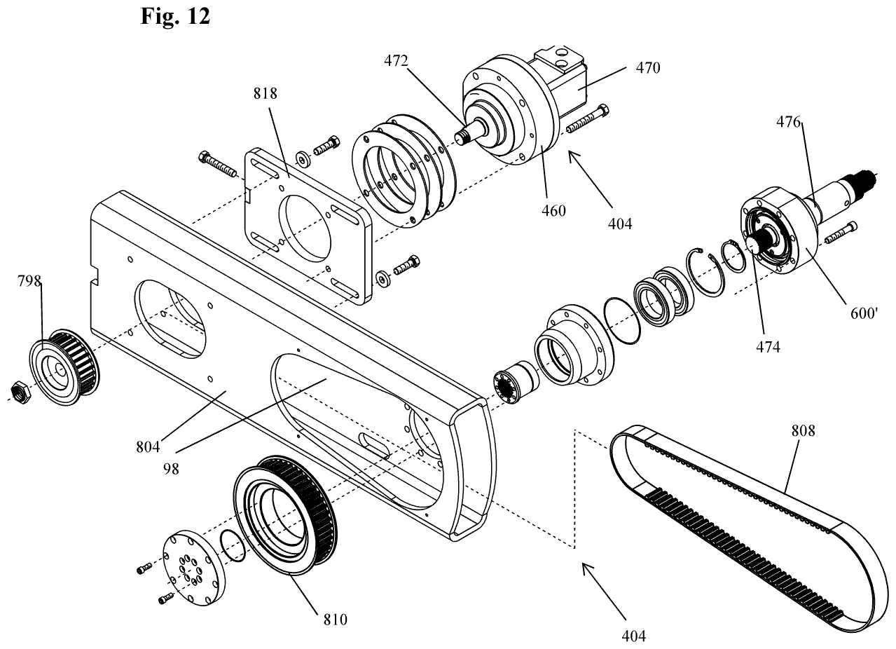

As shown in FIGS. 11-13, in an exemplary embodiment, each of the selectively engageable drive assemblies 402 of the forklift assembly 1 may include a motive power assembly 404 having a motor 470 and optionally a transmission 460. The motor 470, such as a hydraulic motor, is configured to selectively transmit a motive force through the driveline of the drive assembly 402 to cause the hub 410, and thus a wheel 52 mounted upon the hub to turn, thereby propelling the forklift assembly 1. As can be seen with reference to the partially exploded view provided by FIG. 12, a motor 470 may be provided, which may be a hydraulic motor as depicted, though it is contemplated that the motor may instead be any suitable motor, including electric or pneumatic, which when actuated will result in the rotation of the motive power assembly output shaft 472 in a selectable direction. In an embodiment, the drive and direction of rotation of the motor 470 for each of the drive assemblies 402 are independently, and selectively reversible, so as to provide adequate maneuverability to the forklift assembly 1 and minimize the turning radius. The rotatable motor output shaft may be directed into an input opening in a transmission housing 460. The power output from the motive power assembly 404 is provided by a motive power assembly output shaft 472, whether the output shaft form the motor 470, or optional transmission 460, if present. In an embodiment, the transmission housing 460 may contain a gear reduction system, for example, a planetary gear set, which serves to increase the torque output from the motor, while reducing speed of rotation. The output from the motive power assembly 404 is directed to a driveshaft 474, as will be discussed.

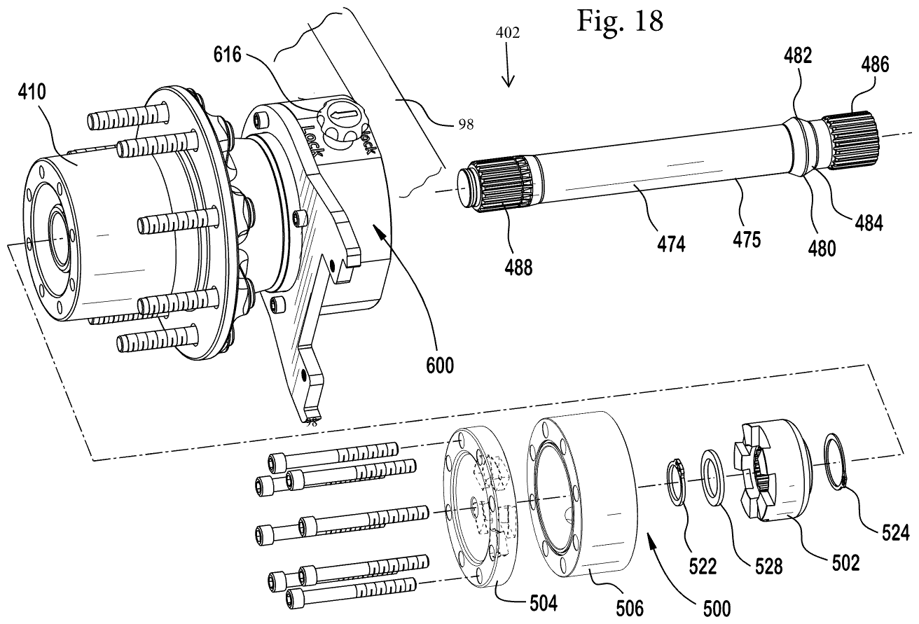

As shown in FIG. 18, the selectively engageable drive assembly 402 may be provided with a selectively engageable clutch assembly 500, providing a mechanism allowing each wheel 52 of a wheel assembly to be in one of two modes of operation, a self-propelled mode where the wheel is driven by the motor, with the driveline engaged; and free-wheel mode, or non-self-propelled mode, where the hub/wheel is allowed to free-wheel independently of any rotation of the driveshaft, and where the driveline is disengaged. While the clutch assembly 500 is engaged, motive forces provided by the motor 470 are directed through the transmission 460, if any, and then by the driveshaft 474, whereby the motive forces may be passed through the clutch assembly 500 to cause the rotation of the hub assembly 410 upon which the wheel 52 is mounted, thereby driving the wheel. While the clutch 500 is disengaged, the wheel and hub 410 may spin freely, independent of the driveshaft 474 and motor 470, as may be required while the forklift assembly 1 is being towed by a powered vehicle between locations. The mechanism of the clutch assembly 500 may be of any suitable type for selectively transmitting torque from the motor to the wheel, as is understood by those skilled in the art, and may include friction, centrifugal, diaphragm, positive, hydraulic, electromagnetic, or vacuum clutches, as non-limiting examples.

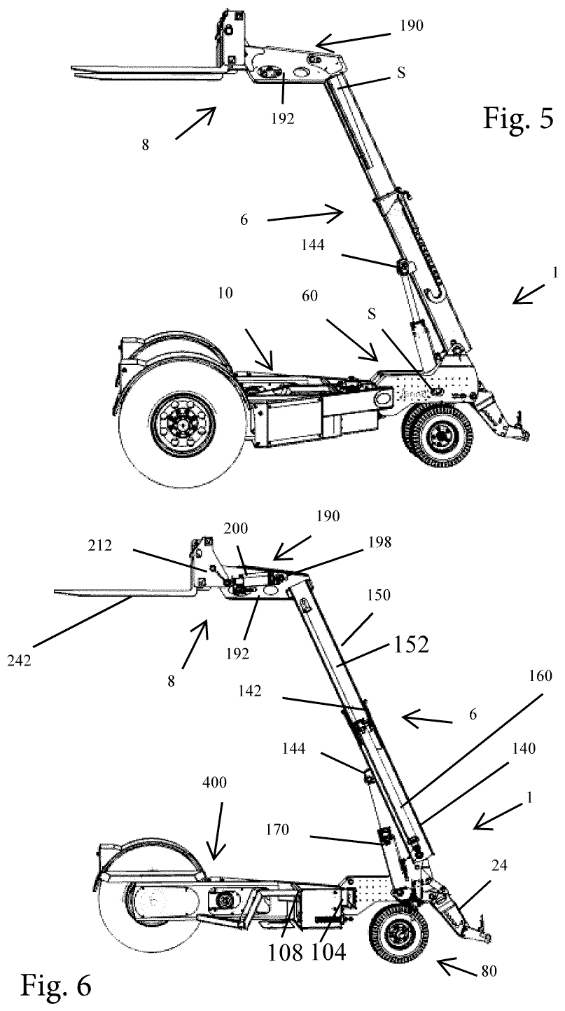

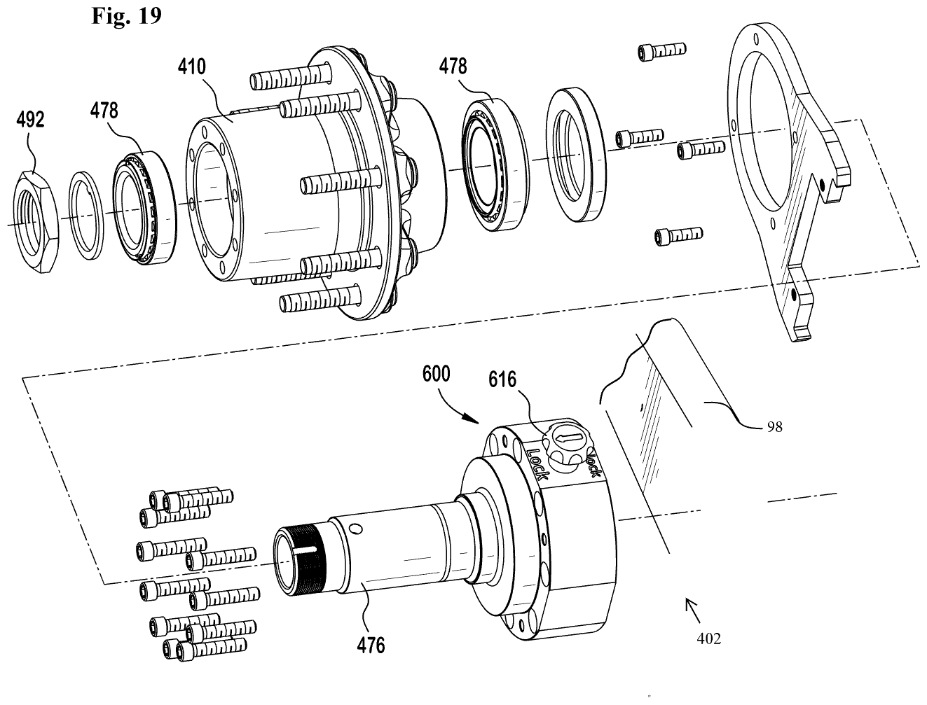

With reference to FIG. 19, the drive assembly 402 is provided with a bell housing 476 with a locking mechanism 600 provided at the bell end of the bell housing. The locking mechanism 600 serves to control whether the clutch assembly 500 will remain engaged or not for transmitting motive forces from a motive power assembly 404 to drive the wheel hub 410 of the wheel assembly 400. Actuation and operation of the locking mechanism 600 will be discussed in detail below. The wheel hub 410 is mounted over the bell housing 476, and rotatably secured thereon with at least one bearing set 478, such as inner and outer roller bearings 478 depicted in FIG. 5. The bell housing narrow end may be threaded, in order to receive a lock nut 492 thereon, and thus can secure the hub 410 onto the bell housing 476, while still allowing rotation of the hub, relative to the bell housing. The bell housing 476 at the open bell end, along with the locking mechanism 600 may be secured to the wheel support plate 98, such as through the use of a flange, and one or more support bearings, as shown in FIG. 122.

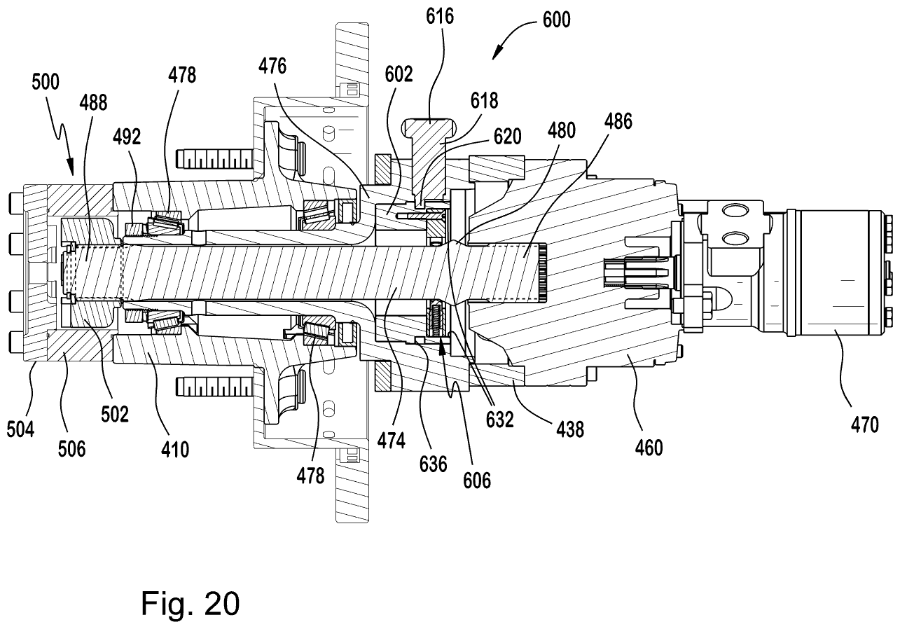

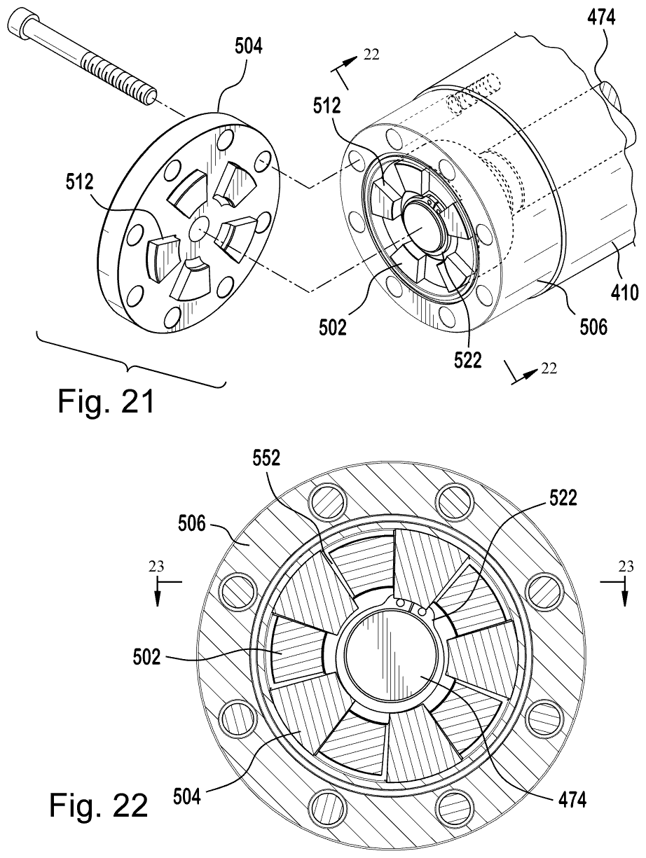

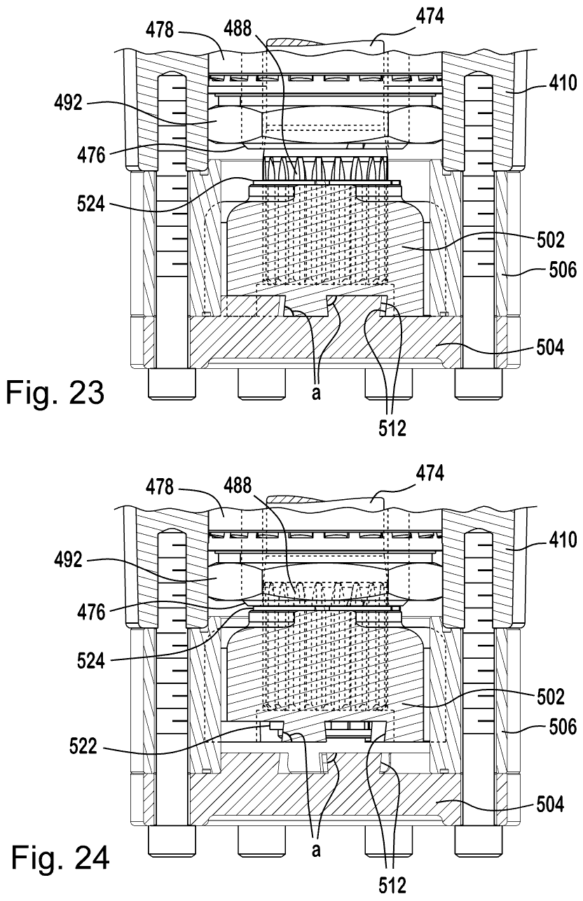

As can be seen with reference to FIGS. 20-24, the clutch assembly 500 may be caused to engage or disengage with the lateral shifting of the driveshaft 474. As shown in FIG. 21, the driving clutch element 502 is fixed to an output end 488 of the driveshaft 474. The driven clutch element 504 is mechanically secured to the wheel hub 410 by one or more fasteners, which may pass through an optional spacer 506. While the driveshaft 474 is in the first position, as shown in FIG. 23, the teeth of the driving clutch element 502 will be engaged with the receiving elements (such as teeth) of the driven clutch element 504, in order to positively transmit the rotation of the driveshaft 474 through the clutch 500 elements and to the wheel hub 410. While the driveshaft 474 is in the second position, as shown in FIG. 24, the teeth of the driving clutch element 502 will not be engaged with the receiving elements of the driven clutch element 504, as the lateral shift of the driveshaft 474 is enough to separate the driving clutch element 502 from the driven clutch element 504 from being in rotational interference. Thus, so long as the driveshaft 474 remains in the second position, the driveshaft 474 may be caused to rotate by the motor, and the driving clutch element 502 will also rotate, yet there as there is no contact between the driving clutch element 502 and the driven clutch element 504, and accordingly the driven clutch element 504, wheel hub 410 and wheel will remain isolated from movement of the driveshaft and motor, if any. Moreover, such as where the forklift assembly 1 is being towed, the driven clutch element 504, wheel hub 410 and wheel will be free to turn, without affecting the driveshaft 474 and motor 470, while the driveshaft 474 remains in the second position, and the clutch is disengaged. The FIG. 20 depicts an embodiment of the locking assembly 600 operating with a driveshaft 474 that is directly engaged with an output from the transmission 460. Operation of the locking assembly 600 and the urging force applied to the driveshaft 474 would be the same irrespective of the manner in which the rotational force for the drive shaft 474 is applied, for example, in an application where the driveshaft power input end 486 was engaged with a belt-driven pulley, as depicted in FIG. 11-13, instead.

In various embodiments, the teeth of the driving clutch element 502, and the teeth of the driven clutch element 504 are provided with side faces 512 to the tooth that are parallel to the complementing side face of the opposing engaging tooth. In an embodiment, the teeth of each clutch element 502, 504 as they engage, are presenting engaging planar surfaces on the side edges 512 of each tooth that are perpendicular to a generally planar top surface of the respective tooth (the plane extending between the top edges of each of the side surfaces of a tooth). In this manner, the teeth of the clutch assembly 500 can slide into engagement when the teeth of each element are at a point or rotation and positioned near each other, with their side faces aligned. In such an embodiment, where there is torque being transmitted through the clutch assembly, friction between engaged planar tooth surfaces may serve to keep the clutch engaged, despite an urging force applied to disengage the clutch assembly, as discussed herein. Once the clutch is unweighted and is thus significantly free from applied torque forces through the clutch assembly, at that point, the adjoining faces of the teeth may be able to slip past each other to disengage the clutch assembly 500, responding to the urging of the locking assembly, as described herein.

One skilled in the art will recognize that alternative top surfaces, in addition to a top planar surface as depicted, may perform similar to the clutch assembly contemplated herein. It is contemplated, that the top surface therefore need not be limited solely to being a planar surface, and may provide, for example, concave or convex surfaces. Care must be taken to ensure that the convex surface does not protrude above the rest of the tooth to the extent that the convex surface might interfere with clutch disengagement. It is contemplated that slight convexity of the tooth profile may aid in engaging the teeth of the clutch assemblies into rotational engagement, as the teeth would seek to slide relative to each other when urged together to enter into an engaged state.

In another embodiment, the teeth of each clutch element 502, 504 present engaging planar surfaces on the side edges 512 of each tooth that are slightly acute relative to the plane of the top surface of the respective tooth, as can be seen with reference to the end-on toothed profiles visible in FIGS. 23 and 24. As shown in profile view, the intersection of the top surface of the tooth with the planar side edge 512 forms an angle “a” that is less than 90°. In this manner, the engaged teeth of the clutch elements 502, 504 will more tightly engage the clutch assembly 500 as torque forces are transmitted through the clutch components 502, 504, such as when motive force is transmitted through the clutch assembly 500 to drive the wheels. In such an embodiment, the acute angles of the sides 512 of the teeth, present complementary angled planar surfaces that would tend to urge the driven clutch element 504 and the driving clutch element 502 towards each other and into tighter engagement as torque forces are transmitted through the clutch elements 502, 504. That is, when viewed in a profile view along the radial axis extending through one of the teeth, the protruding top of the tooth is wider than the rest of the tooth profile, and would appear similar to a dovetail feature, as is known from woodworking, only with the spacing between each of the teeth adjusted to allow a limited amount of rotation in either direction, when the clutch elements are in rotational interference with each other as depicted in FIG. 22. Such spacing between dovetailed jaws can be seen with reference to the FIG. 22, showing in cross section the teeth of driving clutch element 502 and driven clutch element 504 when they are positioned laterally approximated and in rotational interference. Note that there is a small amount of space 552, where the components could be rotated relative to each other, where the space between neighboring sets of teeth corresponds to less than 20°, or less than 15°, or less than 10°, or less than 6°, or less than 3°of rotation from engaging in one direction to the other. To engage such clutch elements with the undercut profiled teeth, the driving clutch element 502 is moved into rotational interference with the driven clutch element 504, by laterally shifting the driveshaft 474 into the first position and adjusting the clutch assembly 500 from the position depicted in FIG. 24 to that depicted in FIG. 23. Engagement of the clutch assembly 500 should be performed before there is significant, or any torque being transmitted through the clutch assembly 500, in order to ease the engagement of the toothed components, such that the teeth of the driving clutch element are able to fit between, and shift into engagement with, the teeth of the driven clutch element 504.

The driven clutch element 504 and the driving clutch element 502 will tend to remain urged together by the dovetail profile of the teeth, for as long as there is torque being transmitted through the clutch assembly 500. This is due to the angle of each of the planar faces on the sides 552 of the engaged teeth, where torque forces would tend to slidingly urge the driving clutch element 502 further towards the face of the driven clutch element 504. Disengagement of the clutch assembly thus requires removal of the torque through the clutch assembly, in order to overcome the dovetail engagement provided by the tooth profile of the engaged clutch components depicted in FIG. 23 and to allow the lateral shifting of the driveshaft 474, and retraction of the driving clutch element 502 out of engagement with the driven clutch element 504. In an embodiment, the unweighting of the clutch and disengagement of the clutch elements may be facilitated by a slight reversing movement of the engagement, in an amount that allows the angled surfaces of the teeth to slide past each other. Thus, disengagement of the clutch assembly 500 will occur only when the clutch assembly 500 is unloaded and substantially free from torque transmission in either direction (from the driveshaft to the wheels, or the wheels to the drive shaft) such that the teeth of the clutch elements 502, 504 may become disengaged, as the driveshaft 474 is then able to return to the second position, and adjusting the clutch assembly 500 from the position depicted in FIG. 23 to that depicted in FIG. 24. With the driveshaft 474 returned to the second position, the teeth of the clutch elements 502, 504 are removed from being in rotational interference, such that the wheel hub 410 is now able to free-wheel and can rotate independently of the driveshaft 474 and motive power source, such as may be beneficial when being towed by a tow vehicle.

In an embodiment, it is contemplated that the driven clutch element 504 of FIG. 21 may be manually reversible in the orientation of mounting, so as to present the face of the driven clutch element 504 with the recessed surface, that is normally positioned to the outside of the clutch assembly 500, instead being positioned to face inwards, and towards the driving clutch element 502. When the driven clutch element 504 is physically removed, and then replaced in this reversed orientation, the clutch assembly 500 will always be disengaged, regardless of the position of the driveshaft 474, such that the hub 410 will free wheel, though it may remain subject to braking application, as previously described. In this manner, should it be necessary, one wheel hub assembly drive system may be disabled, as may be useful in the event of a malfunction, or equipment breakage. The removal and reversal of the driven clutch element 504 is accomplished by removing the fasteners securing the driven clutch element 504 to the hub 410, such that the driven clutch element can be physically removed and replaced with the normally exterior facing recessed surface (as can be seen in FIG. 18) now directed inwards towards the driving clutch element 502.

In an embodiment, one or more of the selectively engageable drive assemblies 402 may provide a driveshaft 474 having a power input end 486, and an output end 488. The driveshaft 474 may be provided with an input pulley mounted on the power input end 486 of the driveshaft 474, such that motive force can be transmitted to the driveshaft via a belt drive, through a belt mounted around the pulley, as can be seen with reference to FIG. 12.

Alternatively, it is contemplated that the power input end 486 of the driveshaft 474 is configured to be rotated by a source of motive power, such as motor 470, optionally with transmission 460 provided between the motor 470 and the driveshaft 474.

The power input end 486 of the driveshaft 474 provides a splined or keyed connection, such that the driveshaft is rotationally fixed, relative to the component causing the self-propelled rotation of the driveshaft 474, whether motor, transmission, or pulley. In this arrangement, the driveshaft 474 has no rotational degree of freedom relative to the power source component, but is provided with lateral degree of freedom, such that the driveshaft is able to slide laterally relative to the position of the power delivery component e.g., motor 470, transmission 460, or input pulley 810 (as shown in FIGS. 12, 13, and 18). The lateral freedom of movement of the driveshaft 474 allows the driveshaft to be controllably moved to engage or disengage the clutch assembly 500 provided in the driveline between the wheel hub 410, and the source of motive power, such as motor 470. The output end 488 of the driveshaft may be mechanically fixed to the driving clutch element 502 with one or more fasteners, to ensure that the driving clutch element 502 is rotationally, and laterally fixed on the end of the output end 488 of the driveshaft 474. In the embodiment depicted in FIG. 18, the output end 488 of the driveshaft 474 is also splined, such that a driving clutch element 502 with a corresponding mating interior surface can be slid onto the output end 488 of the driveshaft. This splined, or other suitable keyed connection, ensures that the driveshaft 488 is rotationally fixed with the driving clutch element 502. As depicted in FIG. 18, the driving clutch element 502 may be laterally fixed upon the output end 488 of the driveshaft 474 through the use of one or more retainers, such as front retainer ring 522 and back retainer ring 524. It is contemplated that one or both of the retainer rings 522, 524 may be provided, secured in corresponding receiving grooves provided on the driveshaft near the splines of the output end 488, in order to provide a physical limit to the lateral movement of the driving clutch element 502 relative to the driveshaft 474, such that the driving clutch element 502 becomes substantially fixed on the output end 488 of the driveshaft, and will move laterally in concert with the lateral shifting of the driveshaft 474. In an embodiment, there may optionally be provided one or more washers 528 between one or both of the retainer rings 522, 524 and the respective surface of the driving clutch element 504 that the respective retainer ring is abutting against. In this manner, the driving clutch element 502 is rotationally fixed to the output end 488 by the splined engagement, but is also fixed with regard to lateral movement, relative to the output end of the driveshaft 474, such that as the driveshaft 474 when caused to shift laterally, and/or rotate, the driving clutch element 502 will move in concert with the output end 488 of the driveshaft 474. Alternatively, it is contemplated that a fastener may be directed through the driving clutch element 502, and secured to the driveshaft 474, such as a threaded central bore in the end of the driveshaft that accepts a fastener, such as a bolt therein.

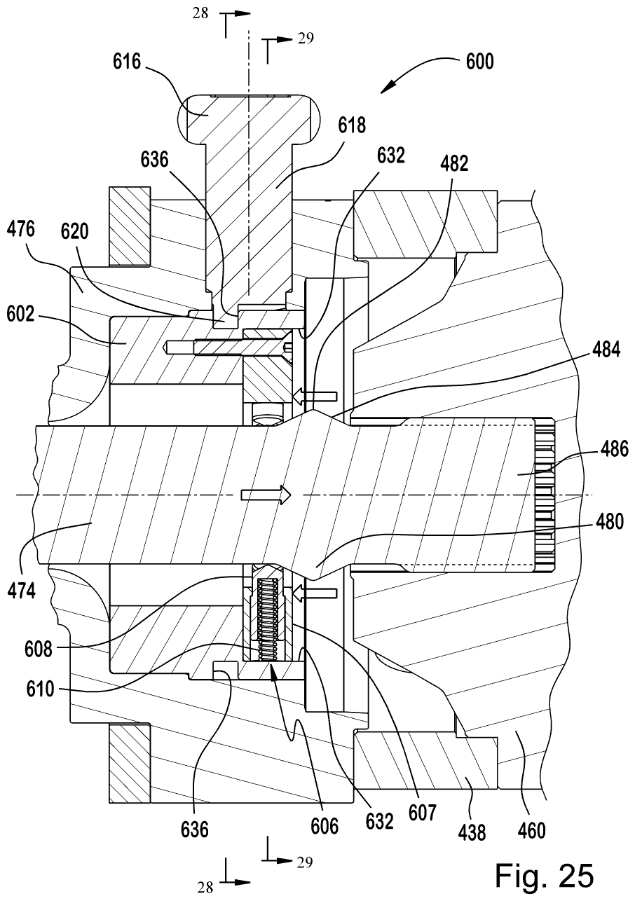

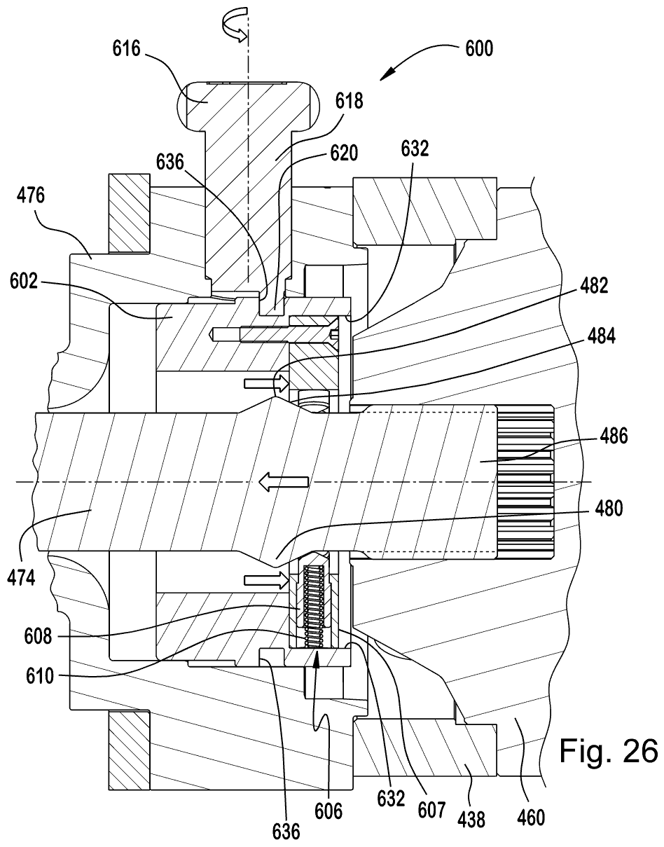

As can be seen with reference to enlarged views in FIGS. 25 and 26, the driveshaft 474 is provided with an annular protrusion 480, shown here as a protruding portion extending around the circumference of the driveshaft 474. As shown, the annular protrusion is provided on the portion of the driveshaft that is to be extended through the locking assembly 600. The annular protrusion 480 may be provided as an expanded ring portion extending beyond the nominal diameter 475 of that portion of the driveshaft, and has an apex 482, at the greatest extent, or peak of the annular protrusion 480. On either side of the apex 482, the annular protrusion 480 provides bearing surfaces 484. As can be seen with reference to FIG. 25, the cross-section profile of the annular protrusion 480 provides the bearing surfaces 484 in the tapering portion from the apex 482 down to a transition point where the annular protrusion ends and transitions to the nominal driveshaft dimensions 475 of the neighboring portions of the driveshaft 474. The tapered profile of the bearing surfaces may be linear, such as the straight ramped profile for the bearing surfaces depicted in FIG. 25, though one skilled in the art that alternative profiles are possible, such as a non-linear taper, which may be provided by a curved or irregular ramped profile. As can be seen in the cross-section view of FIG. 20, the driveshaft 474 at each of the input end 486 and output end 488 may optionally be somewhat varied in dimensions as well, in order to facilitate securement to the connecting portions of the driveline, such as the driving clutch element 502 to the output end 488 of the driveshaft, or the sliding engagement feature, e.g., splines or keyed portions at one, or both ends of the driveshaft. The driveshaft 474 is extended through at least the length of the bell housing 476, with each of the driveshaft input and output ends 486, 488 extending out from the dimensions of the bell housing.

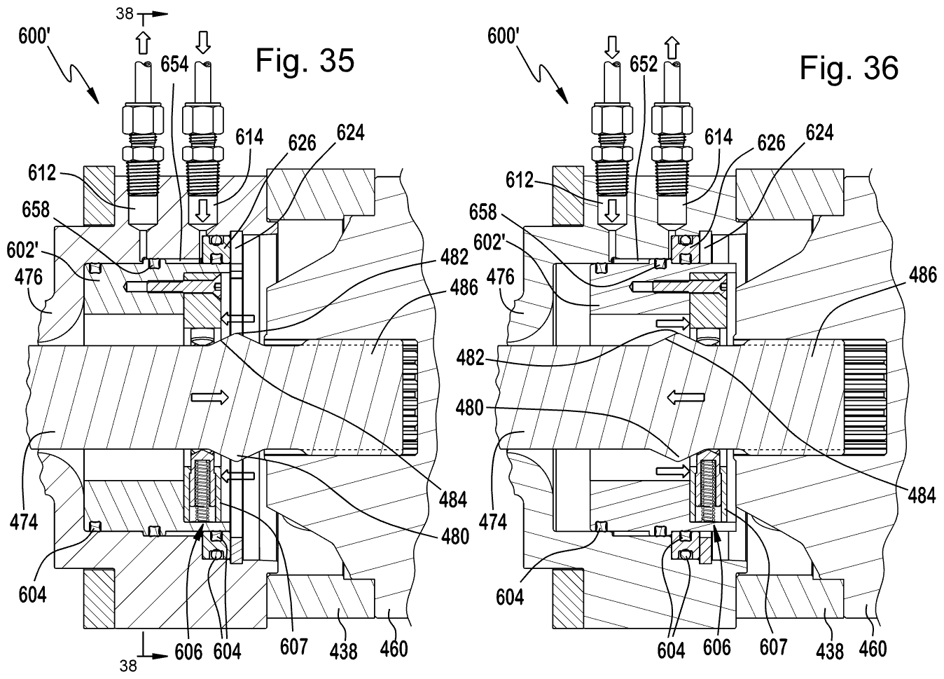

A first embodiment of the locking assembly 600 will be described with reference to FIGS. 20, 25-34. The first embodiment of a locking assembly 600 provides for the user to manually control the setting of the locking assembly 600, and provides a user actuated handle or knob 616, such that the user may rotate the handle or knob so as to selectively place the locking assembly 600 into a locked or unlocked configuration. An alternative locking assembly 600′ depicted in FIGS. 35-38, using like number for like components will also be described below. Unlike the first embodiment of the locking assembly however, the alternative locking assembly 600′ instead relies on the user operating controls that employ a power source, or pressurized fluid source, in order to effectuate the locking or unlocking position of the locking assembly 600'. Thus, control of the alternative locking assembly 600′ configuration may be achieved, for example, by controllably varying fluid pressures within the locking assembly 600′ such as through the use of a fluid pressure source, as in the manner of a hydraulic or pneumatic actuator, as will be explained.

### Manual Locking Assembly

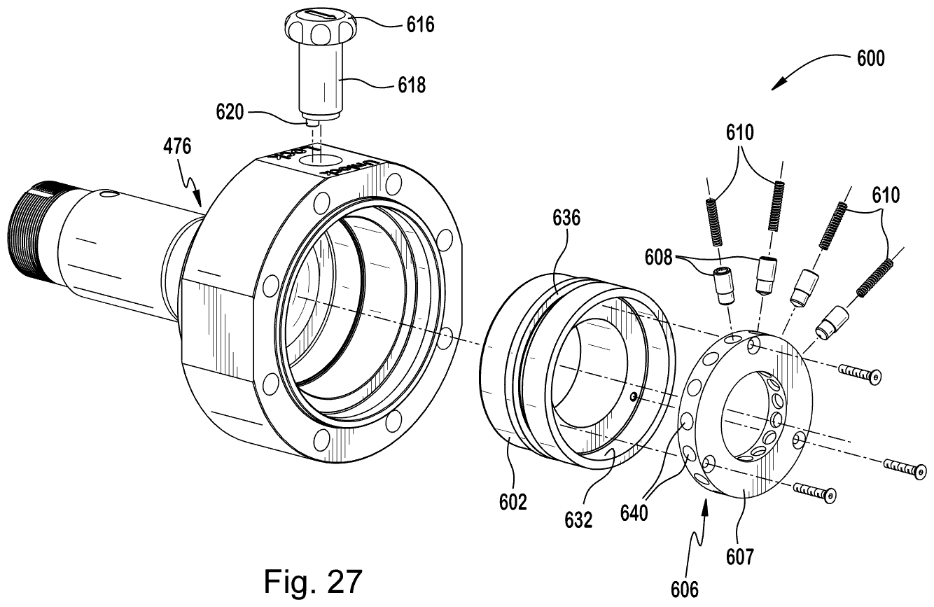

The first locking assembly 600 of FIGS. 20 and 25-34 provides for user operated control of the locking assembly 600 to urge the lateral movement of the driveshaft 474, which may be selectively shifted in first and second directions to control the engagement or disengagement of the clutch assembly 500, as described previously. The locking mechanism 600, as shown in FIG. 20, may be positioned near the open bell end of the bell housing 476, and as can be seen in the exploded view of FIG. 27, the first locking mechanism 600 includes at least the following major components: pushing member 602, urging member 606 and a handle assembly providing a handle 616 on the end of a spindle 618, and having an off-center protruding pin 620.

As shown in the enlarged view of FIG. 25 and the exploded view of FIG. 27, an embodiment of the locking assembly 600 is shown with a pushing member 602 that is a generally annular shape. The cross-section profile of the pushing member is depicted in the cross-section view of the locking assembly 600 depicted in FIG. 20. As shown, the pushing member provides a recess 632 that can receive the urging member 606 therein, such that the urging member can be secured against the pushing member, and fitted within the recess, through the use of one or more fasteners. The pushing member 602 is fitted within the bell housing 476 and can operate as a reciprocating piston that encircles a portion of the driveshaft 474 directed through the bell housing 476. The pushing member 602 is thus configured to translate axially (in a direction parallel to the longitudinal axis of the driveshaft 474). As can be seen with reference to FIGS. 25 and 26, the pushing member 602 in cross-section appears to travel laterally between a first position as shown in FIG. 26, and a second position as shown in FIG. 25.

Axial translation (movement parallel to the longitudinal axis of the driveshaft 474) of the pushing member 602 may be achieved by any suitable actuation method, including mechanical control, electromechanical, pneumatic, or hydraulic control. As shown in FIG. 25, and 26, mechanical control of the pushing member may be directed by the user rotating a knob or handle 616, such that a user can cause the lateral movement of the pushing member 602.

With reference to FIG. 27, and FIG. 25, the spindle 618 is a cylindrical body that extends from the handle 616 and passes through a receiving opening provided in the bell housing 476. The spindle 618 terminates at an end face positioned just above the outer circumference of the pushing member 602. The spindle 618 is configured to rotate about the spindle axis within the bell housing as the handle 616 is operated by the user. The spindle may be retained in position by a friction fit within the opening of the bell housing, or can be secured in any suitable manner, relative to the bell housing, such that rotational movement of the spindle 618 is possible, but the spindle will not readily be removed from the bell housing.

The end face of the spindle 618, away from the handle 616, is provided with a protruding pin 620 that serves as a cam as the pin is mounted off-center from the central axis of the spindle. The pin 620 protrudes from the spindle and is directed into a cam follower slot 636 provided on a portion of the exterior of the pushing member 602. As the pin is off centered on the end of the spindle, rotation of the spindle by operation of the handle 616, will cause the pin 620 to swing in an arc from the position of the pin shown in FIG. 25, to the position shown in FIG. 26. The pin 620 as it is extended into the slot 636 and is retained within the slot as the pin is moved, thereby causes the reciprocating movement of the pushing member 602 between the positions shown in FIGS. 25 and 26. For maximum lateral movement of the pin 620, the spindle may spin through 180 degrees of rotation, though it is contemplated that less rotation may be utilized where the maximum extent of lateral movement of the pin, and therefore lateral travel of the pushing member, is not required. Once the extent of travel is greater than 180 degrees, the extent of travel of the pushing member 602 will appear to be reduced, even though it must travel through the full extent of travel at the 180 degree mark. Alternatively, in addition to varying the extent of rotation of the spindle, one may adjust either, or both of the placement of the pin (distance from the longitudinal center of the spindle), or vary the width dimension of the spindle and the distance of center, in order to provide the desired extent of lateral travel for the pin, and correspondingly control the extent of lateral reciprocation of the pushing member 602.

The urging member 606 provides a collar 607, a plurality of biasing devices 610 and a plurality of plungers 608. The collar 607 is a generally annular ring surrounding the driveshaft 474, positioned near or about the annular protrusion 480 of the driveshaft 474. The collar 607 of the urging member 606 is fitted into the recess 632 of the pushing member 602 and is mechanically secured thereto, for example, with one or more fasteners directed through the collar and into the pushing member. It is contemplated that alternative means of fixing the urging member 606 to the pushing member 602 are possible, and one skilled in the art will recognize that a variety of securement methods could be employed as an alternative to the fasteners shown.

The collar 607 is provided with a plurality of radially oriented openings 640 extending through the radial thickness of the collar. A plurality of radially arranged plungers 608 are provided that can protrude towards the driveshaft 474 from each of the radially oriented openings 640 on the inside edge of the collar 607, with the plungers 608 having a leading end oriented against the driveshaft 474. A biasing device 610, such as a resilient compressible spring, is inserted into one of each of the plurality of radially oriented openings 640 in the collar 607, and against the back end of each respective plunger 608. The biasing device 610 is compressed as the plunger 608 is positioned within the urging member 606, against the driveshaft 474. With the collar 607 of the urging member 606 positioned within the recess 632 of the pushing member 602 and secured thereto, each of the biasing devices 610 would be contained at the outside surface of the collar 607, within the openings 640, by the encircling portion of the recess 632 of the pushing member 602, as can be seen with reference to FIG. 20.

Each of the plungers 608 when positioned within the collar 607 that is secured within the recess 632, are then urged inwards towards the driveshaft 474, as the compressed biasing devices 610 seek to return to an uncompressed state. Thus, each of the plungers are pushed inwards from the radial openings 640 and directing the leading end of each of the plungers 608 against the exterior perimeter of the portion of the driveshaft 474 that has been positioned extending through the locking assembly 600.

Each biasing device 610 may be an elastomeric, resilient member, such as a coil spring, or any other compressible and elastically resilient material that can be provided to push the plungers 608 in the direction of the driveshaft 474 surface. Each of the biasing devices 610 are thus configured to provide a pushing force to each respective plunger 608 of the plurality of plungers, urging the protruding leading ends of the plungers 608 inward against the surface features of the driveshaft 474. In an embodiment, the plungers 608 may be tipped at the leading end with a roller or friction resistant material, such that the plungers can be urged against the bearing surfaces of a rotating driveshaft 474, and not experience or cause significant wear.

In operation of the locking assembly 600 of FIGS. 20, 25-34, the positioning of the pushing member 602 is directly controlled by the user manually throwing a lever or rotating handle 616 having a spindle 618 and off-center protruding pin 620 that engages with and causes the pushing member 602 to reciprocate laterally. In such an embodiment, the spindle 618 operated by the handle 616 or lever with a protruding pin 620 that is positioned off center at the longitudinal end face of the spindle. The pin may be a cam that is slidingly engaged within a cam follower slot 636 provided on the pushing member 602, such that rotational movement of the spindle, by operation of the lever or handle, will cause the pin 620 to move in an arc, and creates a corresponding lateral movement in the pushing member 602 as the pin when traveling through the arc will slide within the slot 636 of the pushing member 602 that receives the pin therein, thereby causing lateral movement of the pushing member. The pushing member 602 will then act upon the urging member 606, altering the positioning of the urging member 606 relative to the driveshaft 474 and the driveshaft protrusion 480, in order to provide an urging force against the bearing surfaces 484 of the protrusion 480 as discussed below.

As depicted in FIG. 26, the handle 616 may be rotated to place the pin 620 in the right most position as the pin travels through an arc by rotation of the spindle 618. The movement of the pin 620 will then serve as a cam, as the pin is caused to slide within the slot 636, serving as a cam receiver, and thereby position the pushing member 602 to the rightmost position. The urging member 606, as it is secured within the recess 632, and secured to the pushing member 602, will be caused to be similarly shift rightwards as depicted in FIG. 26. When the locking mechanism is positioned as shown in FIG. 26, the urging member 606, with the plungers and 608 and biasing devices 610, will now be placed to the right side of the apex 482, and pressing against the right side bearing surface 484. This will apply an urging force against the bearing surface 484 that will urge the driveshaft to shift to the left. This configuration provides the first locking assembly 600 in the locking configuration, where the driveshaft seeks to engage the clutch assembly 500, for creating a positive engagement between the source of motive power connected to the power input end 486 of the driveshaft 474 and the wheel hub 410.

As depicted in FIG. 25, the handle 616 may be rotated to place the pin 620 in the left most position as the pin travels through an arc by rotation of the spindle 618. The movement of the pin 620 will then serve as a cam, as the pin is caused to slide within the slot 636, serving as a cam receiver, and thereby position the pushing member 602 to the leftmost position. The urging member 606, as it is secured within the recess 632, and secured to the pushing member 602, will be caused to be similarly shift leftwards as depicted in FIG. 25. When the locking mechanism is positioned as shown in FIG. 25, the urging member 606, with the plungers and 608 and biasing devices 610, will now be placed to the left side of the apex 482, and pressing against the left side bearing surface 484. This will apply an urging force against the bearing surface 484 that will urge the driveshaft to shift to the right. This configuration provides the first locking assembly 600 in the unlocking configuration, where the driveshaft seeks to disengage the clutch assembly 500, for removing positive engagement between the source of motive power connected to the power input end 486 of the driveshaft 474 and the wheel hub 410.

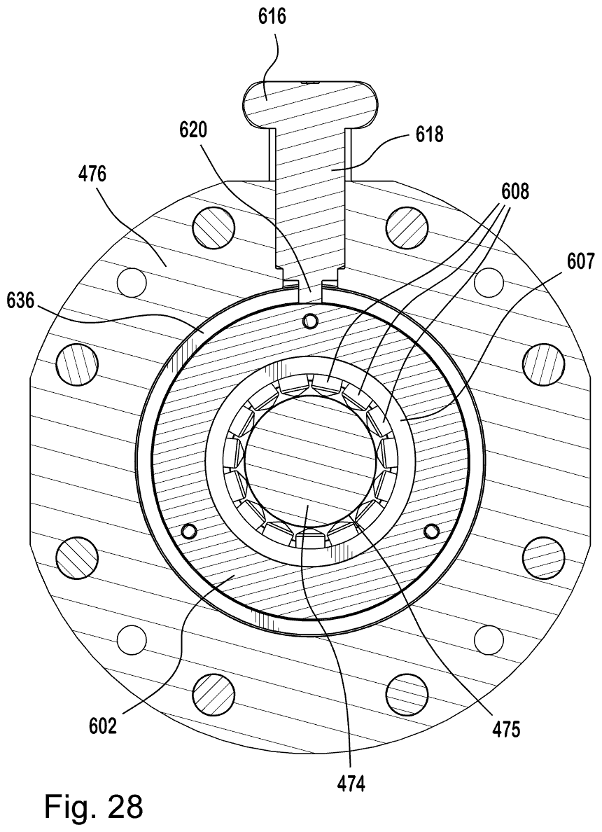

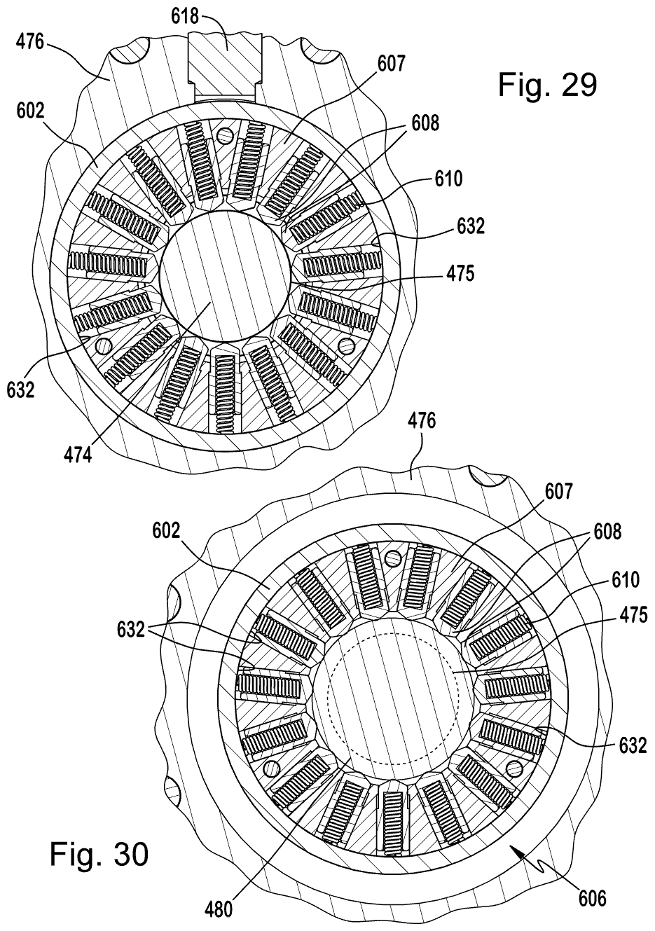

Details on operation of the locking assembly 600 of FIGS. 25-34 will be discussed. For this explanation of the process, it will be assumed that the clutch assembly 500 is in a position that allows the shifting of the driveshaft 474 in response to the urging forces from the urging member 606, in either direction, as the plungers 608 are acting upon the respective bearing surface 484. Thus, this explanation will assume that, where the user rotates the knob 616 and shifts the locking assembly 600 from an unlocked position, as depicted in FIG. 25 to the locked position, as depicted in FIG. 26 the driveshaft 474 will then be assumed to be capable of shifting laterally, without restriction by the relative positions of the components of the clutch assembly 500. As shown in FIG. 25, the locking assembly 600 is depicted with the urging member positioned at the transition of left bearing surface 484 to the nominal driveshaft circumference 475 and having caused the driveshaft 474 to shift laterally to the right and disengaging the clutch. As depicted in FIG. 29, an axial cross-section view of the locking assembly 600 of FIG. 25 is provided, showing a view of the plane passing through the collar 607 of the urging member 606. Another axial-cross section view of the locking assembly of FIG. 25 is provided in FIG. 28, in a plane passing through the pin 620, looking towards the urging member 606. Again, the plungers 608 are shown resting against the nominal circumference 475 of the driveshaft 474, at the transition point to the bearing surface 484. As depicted, each of the plunger 608 are protruding inwards from the collar 607 and are resting against the nominal circumference 475 of the driveshaft 474, with the biasing devices 610 at their lowest level of compression, while contained within the locking assembly. In FIG. 26; the knob 616 has been rotated to a locking position, requiring the plungers to pass over the peak of the protrusion 480 at apex 482, and bearing down against the right bearing surface 484 to urge the driveshaft 474 to the left to engage the clutch assembly 500. As with FIG. 25, the plungers are again resting against the driveshaft 474, at the transition from the right bearing surface 484 to the nominal circumference 475 of the driveshaft 474. The axial cross-section view of FIG. 30 depicts the urging member at a point where the plungers are passing over the annular protrusion 480, such as when cresting over the apex 482. As depicted in FIG. 30, the plungers 608 are urged outwards by the expanded diameter of the driveshaft at the apex 482 of the annular protrusion 480. The nominal driveshaft circumference 475 is shown for reference as the dashed circle. Note that in FIG. 30, the plungers are forced to retract nearly completely into the collar 607, with only the leading ends of the plungers 608 remaining protruding. In this state, the biasing devices 610 are at their peak level of compression, compressed between the retracted plungers 608, and the retaining interior surface of the recess 632. Once the urging member has moved and crested over the apex 482 (in either direction) the compressed biasing devices 610 seek to return to their lesser compressed state, and urge the plungers 608 to bear down on the bearing surface 484, which applies the lateral shifting urging force to the driveshaft 474.

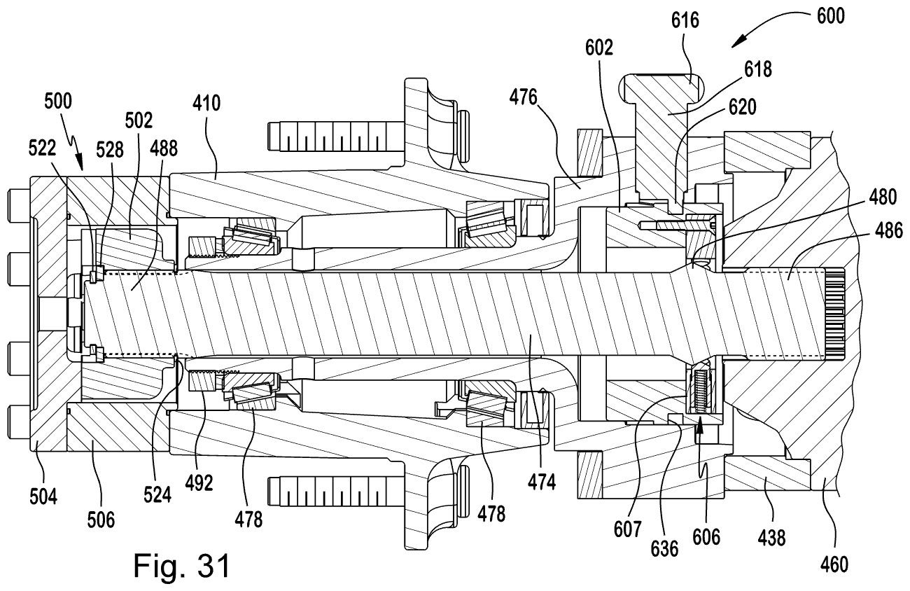

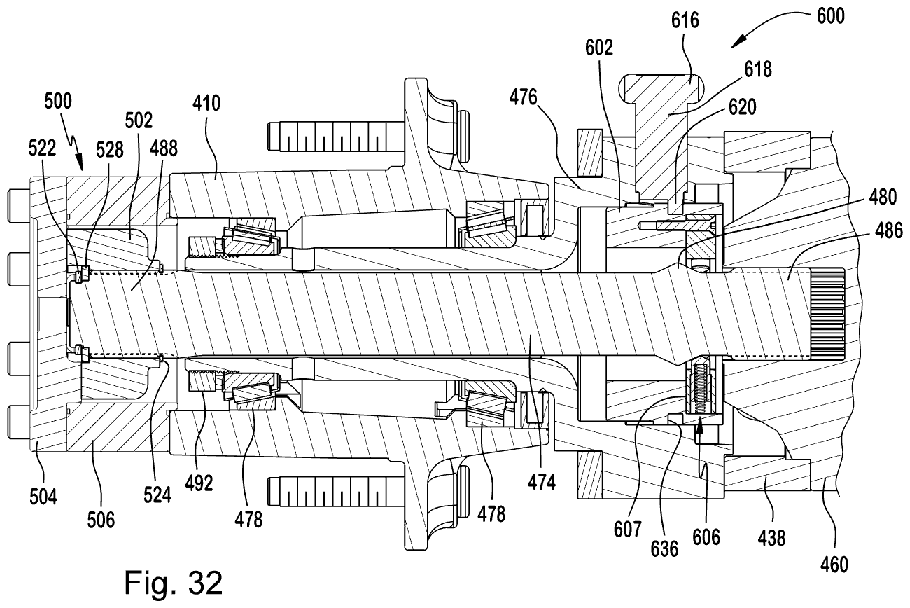

As depicted in FIGS. 31-34, the sequence for transitioning the locking assembly 600 and the driveshaft between and engaged and disengaged state will be discussed. As depicted in FIG. 31, the knob 616 or any suitable handle, has been rotated to move the pushing member 602 along the longitudinal axis of the driveshaft 474, and thus having moved the urging member 606 from being positioned to the left of the apex 482, to a position on the right side of the apex 482. The greatest amount of compression of the biasing devices 610, shown in cross-section view of FIG. 30, occurs as the urging member 606 crests over the apex 482, passing from the left bearing surface 484, and into the position depicted in FIG. 31, with the plungers 608 positioned at the top of the bearing surface 484 positioned just to the right of the apex 482. The plungers 608, with the movement of the urging member 606 to be positioned pressing against the bearing surface 484, now on the right side of the apex 482 of the annular protrusion 480, are thus applying an urging force against the right side bearing surface 484 of the protrusion 480 and thereby applying an urging force to move the driveshaft 474 to the left. Once the clutch assembly 500 is in a state that allows the clutch to become engaged, the driveshaft will be shifted to the left, as shown in FIG. 32.

Thus, with the locking assembly 600 moved to the locking position, the urging member 606 is initially moved to the locking position, and when the driveshaft 474 can respond to the urging, as shown in FIG. 32, would be urged to the left as the plungers 608 ride down the right bearing surface 484, pushing the driveshaft to the left, where the clutch assembly 500 is to become engaged. As shown in FIG. 32, the engaged position of the clutch assembly 500 would be characterized when the driveshaft 474 is laterally shifted to the left, and the plungers of the urging member 606 are positioned at or near the transition point of the right bearing surface 484 to the nominal diameter 475 of the driveshaft 474. Though it is recognized the shifting of the driveshaft into the engaged position can only occur once the clutch assembly 500 is in a state that allows the teeth of the driving clutch element 502 to enter into locking engagement with the teeth of the driven clutch element 504, whereupon the driveshaft 474 will be capable of being shifted towards the locking direction in response to the urging force applied by the urging member 606, and the plungers are caused to slide down the bearing surface of the annular protrusion 480. The ramped surfaces of the annular protrusion thus serve as bearing surfaces, where the plungers 608 are urged against the bearing surface 484 by the biasing devices 610 retained within the collar 607. The force applied by the plungers against the bearing surface of the annular protrusion 480 on the driveshaft 474, once the plungers are positioned to the right of the apex 482, would then urge the driveshaft 474 to shift laterally in response to the collective pressure applied through all of the plungers 608 of the urging member 606. Thus, once the pushing member is pushed to the right by controlled actuation (whether by manual operation, or hydraulic as shown in FIGS. 35-38), the urging member 606 is then also pushed to the right, caused to crest over the apex 482 of the protrusion 480 on the driveshaft 474, whereupon continued inward pressure by the plungers 608 bearing down on the right side bearing surface of the annular protrusion 480 would result in the driveshaft 474 being urged to shift laterally (as shown, in the leftwards direction). The shifting of the driveshaft laterally, once permitted by the clutch assembly, will cause the driveshaft 474 to be urged towards the locking position, such that the clutch assembly 500 becomes engaged for transmitting motive force applied to the drive shaft through to the wheel.

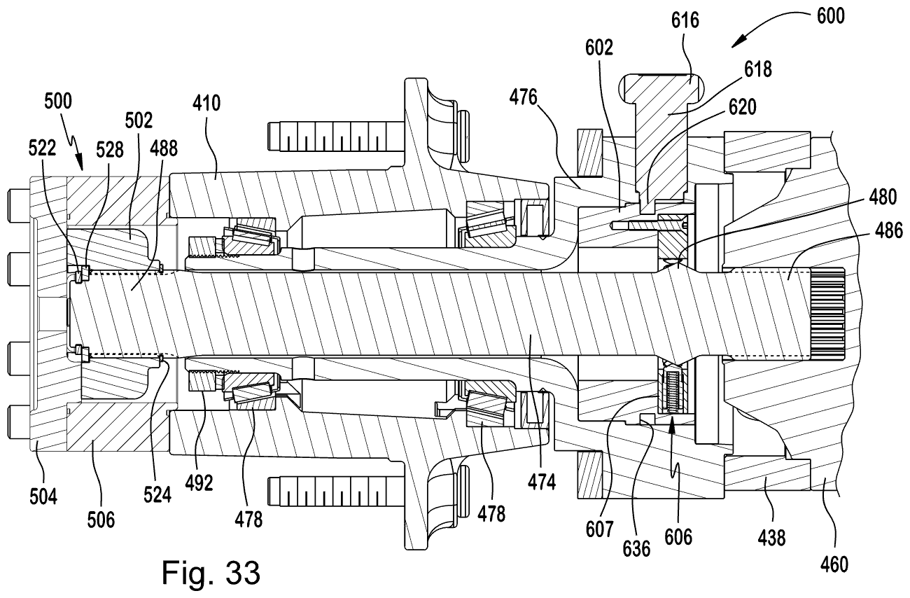

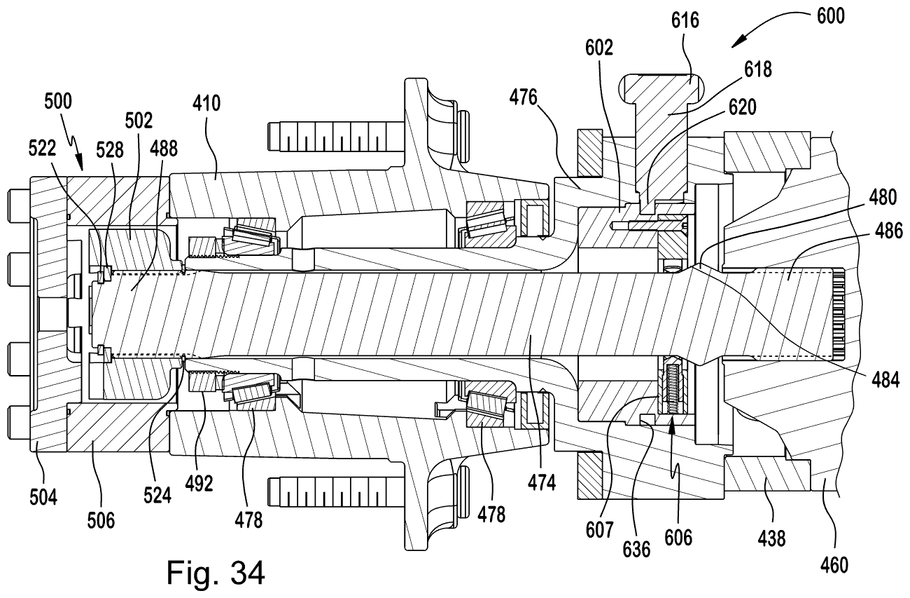

In reversing the actuation of the locking assembly 600, now with reference to FIG. 33, the knob 616 may be rotated to place the pin in the opposite position, urging the pushing member 602 and the urging member 606, towards the left. The urging member as it is moved will cause the plungers to slide laterally over the surface of the driveshaft 474, now in a direction from right to left. The urging member 606 would be caused to pass over the apex 482 of the annular protrusion 480 provided on the driveshaft 474. In passing over the apex, the plungers 608 would again be forced outwards and retract into the collar 607, compressing biasing devices 610 as the plungers ride up the ramped surface of the bearing surface 484. The greatest amount of compression in the biasing devices 610 is created as the plungers 608 collectively crest past the apex 482 of the annular protrusion 480, then are positioned against the bearing surface 484 on the left side of the apex 482, as depicted in FIG. 33, and now applying an urging force against the driveshaft 474 to move to the right and towards the disengaged position. As before, actual shifting of the driveshaft may not occur until the clutch assembly is unweighted, whereupon the components of the clutch assembly 500 can disengage, so as to not transmit motive forces therethrough. As shown in FIG. 33, the driveshaft 474 may be urged to the right, but may not necessarily become effective immediately in shifting the driveshaft. Only once the clutch assembly 500 is free from torque transmission, then the driveshaft 474 may shift rightwards to the disengaged position. The disengaged position is depicted in FIG. 34 and would be characterized by the state when the driveshaft 474 has been laterally shifted to the right. This may occur only so long as the clutch assembly 500 is in a state that allows the teeth of the driving clutch element 502 to escape out of locking engagement with the teeth of the driven clutch element 504. At this point, with the clutch unloaded and not transmitting torque through the clutch assembly, then the driveshaft 474 will be allowed to start to shift towards the disengaged direction, as the plungers 608 are urged against, and caused to slide down the left bearing surface 484 of the annular protrusion 480 on the left side of the apex 482 of the protrusion 480. The ramped surfaces of the annular protrusion 480 serve as bearing surfaces 484, where the plungers 608 are urged against the bearing surface by the biasing devices 610 retained within the collar 607. The force applied by the plungers 608 against the bearing surface 484 of the annular protrusion 480 on the driveshaft 474, once the urging member 606 is positioned to the left of the peak, would then urge the driveshaft 474 to shift laterally to the right in response to the collective pressure applied through all of the plungers 608 of the urging member 606. Thus, once the pushing member is pushed to the left by controlled actuation (whether manual operation, or alternatively by hydraulic or other alternative actuation method), the urging member 606 is then pushed to the left, crested over the peak of the protrusion 480 on the driveshaft 474, such that continued inward pressure by the plungers 608 bearing down on the left side bearing surface 484 of the annular protrusion 480, would result in the driveshaft 474 being urged to shift laterally (as shown, in the rightwards direction) to cause the driveshaft 474 to be urged towards the disengaged position, characterized by the clutch assembly 500 being disengaged for allowing the wheel hub 410 to free wheel, relative to the driveshaft 474.

With reference to FIGS. 31 and 33, the plungers 608 are shown urging against a respective bearing surface 484, pushing against the sloped surface on a respective side of the apex 482 of the annular protrusion 480, and thereby creating a net urging force to the driveshaft 474, urging the driveshaft to shift laterally. Notably, the operation of the locking assembly 600, in applying merely an urging force against the bearing surface 484 of the driveshaft 474 in either direction, will be subservient to the relative positions and forces applied through the clutch assembly 500 in determining when the lateral movement of the driveshaft will occur. That is, the driveshaft may be urged in a respective direction through the operational control of the locking assembly 600 as has been described above, however, the shifting movement of the driveshaft 474 does not occur until the time that the elements 502, 504 of the clutch assembly 500 are positioned such that they are physically capable of being moved laterally to engage or disengage, as appropriate. Thus, the proper positioning of the components 502, 504 of the clutch assembly 500 becomes a necessary condition for allowing the urging force applied to the driveshaft 474 through the locking assembly 600 to become effective. The necessary condition for transitioning the clutch assembly 500 between an engaged and disengaged state is then determinative of when the applied urging force directed against the bearing surface 484 of the driveshaft 474 can be made effective.

So long as the clutch assembly 500 is not in a position for shifting between the engaged and disengaged state, then the urging force applied to the driveshaft 474 (as depicted in FIGS. 31 and 33) through the actuation of the locking assembly 600 will remain applied, in that the plungers 608 will continue to push against the respective bearing surface 484 on the annular protrusion 480, until the clutch assembly 500 allows the driveshaft 474 to be shifted. At that point, the plungers 608 bearing down the bearing surface of the protrusion 480, cause the driveshaft 474 to be shifted laterally. Once the driveshaft 474 is fully shifted in one direction (as depicted in FIGS. 32 and 34), the plungers 608 will be positioned applying none or only minimal force against the bearing surface at the respective end extent of the annular protrusion 480, with the plungers 608 positioned near the transition point between the protrusion 480 to the body of the driveshaft 474.

Factors for allowing the shifting of the clutch between engaged and disengaged, when urged to do so by the locking assembly 600, include the extent to which torque remains applied through the clutch assembly 500 (preventing disengagement), and/or the physical location of the teeth of the clutch components 502, 504 that might interfere with engagement of the teeth of the clutch components. For example, the clutch assembly 500 may only become disengaged when the magnitude of torque force being directed through the clutch assembly 500 is substantially none, such that the urging force from the locking mechanism 600 can overcome restraining force in the clutch from the dovetail arrangement of the teeth, or even friction between opposing teeth surfaces against each other, that seeks to keep the clutch assembly engaged. Once the disengaging force from the urging member 606 acting upon the driveshaft bearing surfaces 484 exceeds the restraining force of the teeth of the clutch assembly 500, then the driveshaft 474 may shift along its longitudinal axis, in order to allow disengagement of the clutch assembly 500. In the reverse operation, in order to allow engagement of the clutch assembly 500, the teeth of the clutch components 502, 504 must be properly positioned at a point where lateral movement of the driving clutch element 502 is possible, and the teeth of the driving clutch element 502 can be fitted into the space between teeth of the driven clutch element 504, to allow engagement of the clutch assembly 500.

Thus, when the clutch assembly 500 is capable of being engaged or disengaged becomes a necessary condition that is the dominant factor in determining whether an urging force by the locking assembly 600 acting against a bearing surface 484 of the driveshaft 474 will become effective or remain applied as a static force, in order to cause the lateral movement of the driveshaft 474 at the urging of the locking assembly 600.

A benefit of the operation of the locking mechanism 600 described herein is that the locking mechanism can be actuated to cause the urging member 606 to be controllably moved between a first urging position and a second urging position (characterized by being positioned on either side of the apex 482 of the annular protrusion 480), and is thus configured to apply a biasing force to the driveshaft 474 through the plungers 608 acting upon the bearing surfaces 484 of the driveshaft 474, such that the driveshaft would be merely urged into either a first position (e.g. a locked position), or a second position (e.g. an unlocked position). However, the movement of the driveshaft 474 is only possible (where the urging force becomes effective) when the condition of the clutch assembly 500 components 502, 504 allows the lateral shifting movement of the driveshaft 474 as described above. That is, the condition of the clutch components 502, 504 becomes a dominant factor in determining whether the driveshaft 474 will shift one way or the other, when there is urging applied to the driveshaft 474 through operation of the locking assembly 600. In this manner, the locking mechanism may be actuated or controlled by the user, however, the actual engagement or disengagement of the driveline will not occur until it is safe for the transition to happen. For example, if the teeth of the clutch assembly components 502, 504 are positioned such that there is lateral interference between the teeth moving into rotational engagement, for example, such as when the opposing teeth of the clutch assembly components are overlapping when viewed along the axis of the driveshaft, then the driveshaft 474 remains unable to shift into a locking position, and even if urged to do so by the operation of the locking assembly. The driveshaft 474 will not move laterally into the locking position until such time as the teeth are no longer interfering with and preventing the driveshaft 474 movement needed to engage the components 502, 504 of the clutch assembly 500, e.g., where the wheel has been rotated to position the teeth of the driven clutch element out of interference, and are free to enter into rotational interference with the teeth of the driving clutch element. Similarly, if the clutch assembly 500 is already engaged and transmitting rotational force between the power source and the wheel (or vice versa), the shape of the teeth being slightly undercut and presenting a dovetail profile, will tend to keep the clutch assembly 500 engaged, despite the operation of the locking assembly 600 being moved into a disengaging position, where the driveshaft is urged laterally into a disengaged state. In this state, despite the urging applied to the driveshaft 474 by the urging member 606 to shift towards the disengaged position, the disengagement of the components 502, 504 of the clutch assembly 500 is only made possible when there is no torque being transmitted through the clutch assembly 500, either from the motor to the wheels, or from the wheels to the motor, such that the clutch assembly 500 is free from transmitting any torque force. Only then will the urging forces applied through the locking assembly 600 become effective to shift the driveshaft 474 laterally and cause the disengagement of the clutch components 502, 504 of the clutch assembly 500.

This configuration may be helpful for example, when the forklift assembly 1 is operated in self-propelled mode on a sloped surface. Safely converting the forklift assembly 1 to towing operation (not self-propelled mode) may require unweighting the clutch assembly and/or shifting of the wheel assemblies, as has been described, as well actuation of the locking assembly 600 into the unlocked state.

In an exemplary application, the various embodiments of the locking assembly 600 described herein providing merely an urging force to the driveshaft 474 for engaging or disengaging of the clutch assembly 500 may be useful in a situation where the forklift assembly 1 is operated in self-propelled mode and has been parked on a non-level surface. In such an instance, the clutch assembly 500 of the forklift assembly 1 is provided in a mode that is engaged for self-propelled movement. When desired to convert from self-propelled mode to the tow-behind mode, the user may actuate the locking assembly 600 of the wheel hub assemblies 402, in order to have the urging member 606 moved, as described above, to apply an urging disengaging force to the driveshaft 474 in order to disengage the clutch assembly 500. However, with the weight of the forklift assembly being transmitted through the driveline to one or more of the wheels 52, on the non-level surface, the engaged driveline would serve to prevent freewheeling of one or more of the wheel hubs 410. It is not until the clutch assembly 500 of each respective wheel hub assembly 402 is no longer transmitting torque forces through the clutch assembly 500 that the disengagement of the driveline would be allowed to occur. Thus, when the weight of the forklift assembly 1 is taken off the driveline of each of the wheel hub assemblies 402, and is instead taken up by the tow vehicle then any of the clutch assemblies 500 that remained under driveline tension would become disengaged and allow the forklift assembly to be towed away with the wheel hub assemblies 402 capable of freewheeling.

Similarly, so long as the driveshaft 474 of each wheel hub assembly 402 of the forklift assembly 1 remains urged into the disengaged state by the positioning of the urging member as shown in FIG. 20, then the driveshaft 474 would remain urged in a direction that prevents clutch engagement. It is only when the locking mechanism is actuated, and the urging member shifted to the other side of the protrusion 480 that the driveshaft 474 would be urged to have the clutch assembly for each of the wheels engaged. Moreover, the shifting of the driveshaft would not occur until the wheels are static, and positioned such that the teeth of the respective clutch elements are aligned properly for lateral engagement into a position where they will enter into rotational interference (i.e., the clutch engaged) for transmitting drive forces through the drive line.

The distance that the driveshaft 474 will shift between the engaged state and the disengaged state is equivalent to the distance measured between the transition point on either side of the annular protrusion 480, as each of the bearing surfaces transition to the nominal diameter of the driveshaft. As the driven clutch element is fixed to the power output end 488 of the driveshaft 474, the distance that the driven clutch element 502 will shift, in order to move between the engaged clutch and disengaged clutch assembly, or vice versa, will also be the same as the measured distance between each of the transition points present on either side of the annular protrusion 480.

It is contemplated that adjustment to the magnitude of the urging force can be made by varying one or more of: the number of plungers acting upon the bearing surfaces, the cumulative inward biasing force applied by all of the biasing devices pushing the plungers towards the driveshaft; and the steepness of the angled surface provided as the bearing surfaces of the annular protrusion. For example, a relatively greater magnitude of urging force through the operation of the locking assembly 600 is created with one or more of: increased biasing device force (e.g., spring rate), increased number of plungers each urged inwards by a biasing device; and increased steepness of the angle of the bearing surface, relative to the longitudinal axis of the driveshaft. Conversely, a lesser urging force through the operation of the locking assembly 600 can be achieved by one or more of: decreasing the biasing device forces, such as by reducing the spring rate; decreasing the number of plungers; or providing a shallower angle to the bearing surface that the plungers are being urged against. It is contemplated that the annular protrusion 480 need not necessarily be symmetrical, and thus it is contemplated that by varying the angle of the surface for each of the bearing surfaces 484, the urging force acting upon the driveshaft 474 may be unequal depending on the direction of the urging force being applied against the driveshaft bearing surface. Thus, one may control the relative magnitude of force applied through the locking assembly 600, for independently urging each of the engagement or disengagement of the clutch assembly 500, using the teachings herein.

It is contemplated that the locking mechanism 600 may be controlled through any suitable actuation method, including manual action (e.g., lever operated) as shown in the embodiment of FIG. 33, or actuated movement, such as hydraulic, or pneumatic operation, such as is shown in the embodiment of the locking assembly 600′ of FIGS. 35-36, and discussed below. One skilled in the art will also recognize that electronic control e.g., solenoid actuation, or electromechanical or servo actuators may be similarly provided to cause the pushing member 602 to be reciprocated within the locking assembly and thus operate in a manner similar to the locking assembly embodiments described herein. Any of these control methods may be utilized to directly control the reciprocating movement of pushing member 602 or 602′, which is secured to the urging member 606. The pushing member 602 or 602′ may be in the form of a piston element.

In the embodiment depicted of the alternative locking mechanism 600′ depicted in FIG. 35, the pushing member 602′ is actuated by pressure differentials created within chambers alongside the pushing member 602. The actuation will be described with reference to hydraulic actuation, thought it contemplated that one skilled in the art will recognize that a pneumatic pressure system would perform similarly, where the movement of the pushing member 602′ is controlled directly by the introduction of gas pressure. The system for actuating the locking mechanism may utilize the same power source previously described as providing for various actions of the forklift assembly 1, such as steering, motive force, and movement of the actuators for the storage bin or platform.

### Hydraulic or Pneumatic Locking Assembly

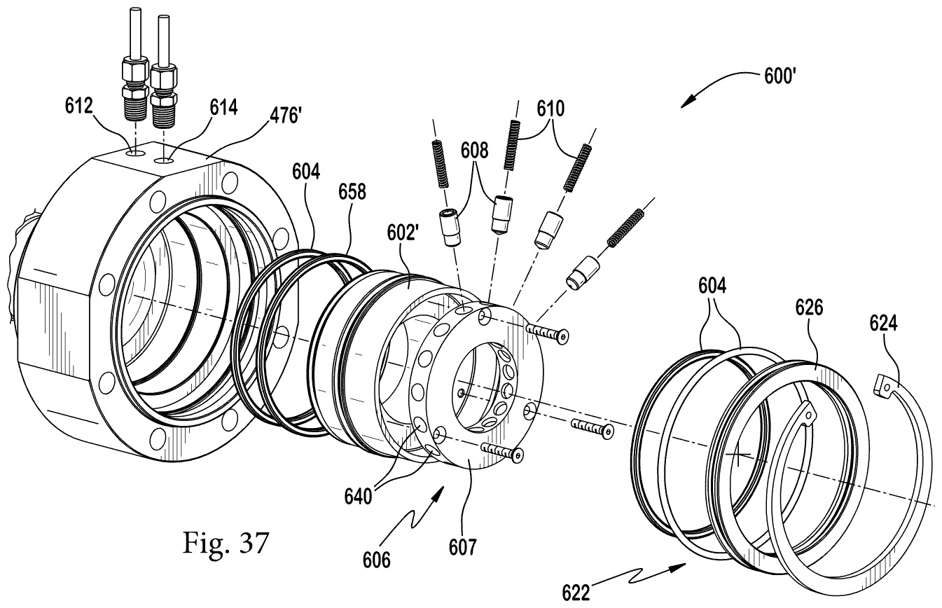

With reference to FIGS. 35-38, details of another embodiment of the locking assembly 600′ utilizing pressure differentials to control the locking assembly actuation will be discussed. The locking mechanism 600′ performs a similar function and in a similar sequence of operations as the locking mechanism 600 previously described, only with the actuation of the components within the locking mechanism 600′ being controlled by selectively manipulating the pressures that act upon the pushing member 602′, as an alternative to the operation by manual rotation of a knob 616 as previously described. The effect of locking assembly 600′ in operation will be identical to that previously described, only with the movement of the pushing member 602′ and urging member 606 being actuated to selectively apply urging forces upon the driveshaft 474 by a user operating a control system that selectively manipulates pressures in a system to place the locking assembly 600′ into a locked or unlocked configuration. The locking mechanism 600', as shown in FIG. 35, and in exploded view of FIG. 37, may be positioned near the open bell end of the bell housing 476, and includes at least the following major components: pushing member 602′, urging member 606 and retainer assembly 622. The urging member 606 is as previously described, fitting within a recess 632 of the pushing member 602′, and functions similarly in applying an urging force to bearing surfaces 484 of a protrusion 480 provided on the driveshaft 474, as the urging member 606 is positioned relative to the driveshaft 474.

As before, the pushing member 602′ of the alternative locking assembly 600′ has a generally annular shape and encircles the driveshaft 474. The pushing member 602′ is fitted within open, bell-end of the bell housing 476′. The cross-section profile of the pushing member 602′ is depicted in the cross-section views of the locking assembly 600′ depicted in FIGS. 35 and 36. As shown, the pushing member 602′ provides a recess 632 that can receive the urging member 606 therein, such that the urging member can be secured against the pushing member when fitted within the recess through the use of one or more fasteners. The pushing member 602′ is configured to operate as a reciprocating piston that encircles a portion of the driveshaft 474 passing through the bell housing 476′. The pushing member 602′ is thus configured to translate axially (in a direction parallel to the longitudinal axis of the driveshaft 474). As can be seen with reference to FIGS. 35 and 36, the pushing member 602′ in cross-section appears to travel laterally between a first position as shown in FIG. 36, and a second position as shown in FIG. 35. Axial translation of the pushing member 602 may be achieved by any suitable actuation method, including mechanical control, electromechanical, pneumatic, or hydraulic control. As shown in FIGS. 35-38, control of the pushing member 602′ may be actuated by varying the pressure in chambers surrounding the pushing member 602′, each chamber being provided on opposing sides of a medial seal 658. In this embodiment, the pushing member 602′ is moved by introduction of fluid pressure through one of first port 612, or second port 614, while allowing release of pressure out the other port, such that a user may direct the lateral movement of the pushing member 602′ between the positions depicted in FIGS. 35 and 36.

The axial movement of the pushing member in the direction depicted in FIG. 35 is limited by the bell housing 476′, where the inside surface provides a hard stop to the extent of travel of the pushing member 602′. With reference to FIG. 36, axial movement of the pushing member 602′ is limited in the directions shown by the presence of a retaining assembly 622.

The retaining assembly 622 provides at least a retainer ring 624, that can be fitted into a groove in the bell housing 476. The retainer assembly 622 may also provide a collar seal 626 and may include one or more seals 604. The retainer assembly 622 provides a stop to the limit the extent of travel of the pushing member 602′ and urging member 606, in the direction depicted in FIG. 36. In an embodiment, the retainer ring 624 may be provided as a snap-ring, C-clip, E-clip, or other retaining ring forms that will be familiar to those of skill in the art. The retainer ring 624, once fitted into a groove provided in the interior surface of the bell housing 476, provides a shoulder that limits the travel of the pushing member 602′ and urging member 606, as it is mechanically secured to the pushing member 602'. Additionally, the retainer assembly 622 having a collar seal 626, such as that depicted in FIG. 37, and shown positioned in FIGS. 35 and 36, may provide a leak proof chamber for pressure control of the pushing member 602′, as will be discussed.

For the alternative embodiment of the locking assembly 602′, as shown in FIGS. 35-38, the pushing member 602′ is axially translated by controlling pressures in distinct chambers in contact with the pushing member, as will be discussed. Where the pushing member 602′ is actuated by pneumatic or hydraulic actuation, the pushing member may be provided with one or more seals 604 provided at the interface of the pushing member 602′, the bell housing 476′, and at the interface of the collar seal 626 with the bell housing 476′ and pushing member 602′. These seals 604 may be provided as sealing annular ring components that are fitted into retaining grooves, as will be familiar to those of ordinary skill in the art and can serve to retain fluid pressures contained within the respective chambers 652,654. In an embodiment, the seals 604 may be O-rings or other elastomeric seals that are mounted on the body of the pushing member and may partially reside within grooves provided on the pushing member 602′. The seals 604 provide sealing to the chambers around portions of the pushing member 602′ and accommodate sliding movement of the pushing member 602 within the bell housing 476. As depicted in the embodiment of FIGS. 35-38, the pushing member 602′ may be provided with a medial seal 658 that separates the first chamber 652 from the second chamber 654. Additionally, seals 604 may be provided, specifically against sealing collar 626, in order to provide a sealed chamber for pressure actuation of the pushing member 602′.

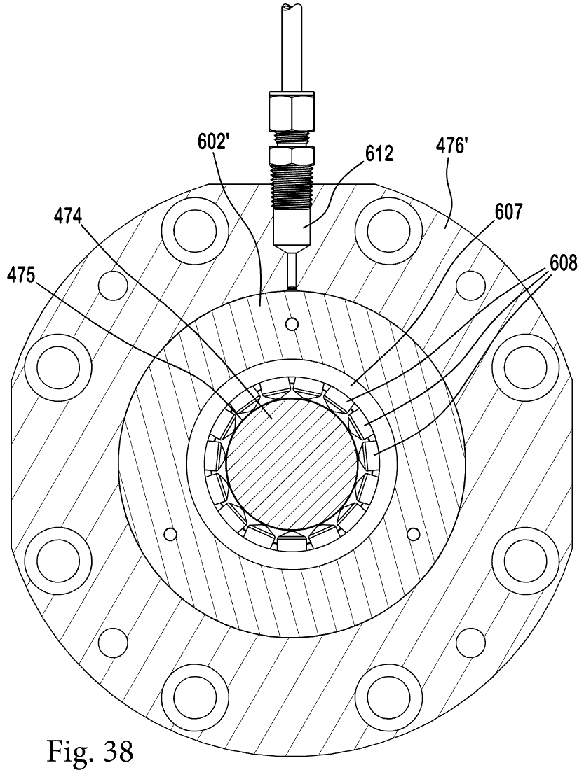

With reference to FIGS. 35 and 36, the operation of a second embodiment of the locking assembly 600′ is shown. As shown in FIG. 36, pressurized fluid may be introduced in the form of hydraulic fluid directed from a fluid reservoir source and into the first port 612, which is in fluid communication with the first chamber 652. The first port 612 is depicted in FIG. 36 as the leftmost port, and feeds into the first chamber 652, which is shown positioned to the left of the medial seal 658. The second chamber 654 is in fluid communication with the second port 614. Simultaneously with the introduction of fluid pressure into the first chamber 652, fluid may escape or pressure may be released out the second port 614, as pressure is relieved from the second chamber 654, shown positioned to the right of the medial seal 658. The increased pressure in the first chamber 652, once elevated above that in the second chamber 654, will then urge the pushing member 602′ in a first direction, shown in FIG. 36 as being to the right. The movement of the pushing member 602′ will also move the urging member 606 to the right and may travel until the urging member 606 is restricted from further movement against the retainer assembly 622, as depicted in FIG. 36. Movement of the urging member 606 in either direction, for example, as depicted towards the right, will cause the plungers 608 to travel laterally over the surface of the driveshaft 474, and will place the plungers in a position bearing down against the right side bearing surface 484 of the driveshaft 474. Assuming that the clutch assembly 500 is in a position that allows the driveshaft 474 to be capable of laterally shifting, collective pressure from each of the plungers 608 of the urging member 606 would bear down on the right bearing surface 484, and urging the driveshaft 474 to shift to the left as the plungers 608 ride down the bearing surface, until the drive shaft is fully shifted, characterized by the plungers being positioned at the transition point on the driveshaft 474 where the bearing surface 484 transitions to the nominal driveshaft circumference 475, as depicted in FIG. 36, and in axial cross-section view in FIG. 38.

Reversal of the pushing member 602′ movement may be accomplished by directing pressurized fluid into the second port 614, to pressurize the second chamber 654, and allowing the relief of pressurized fluid from the first chamber 652, out through the second port 614. Accordingly, the pushing member 602′ would be urged is a second direction, shown in FIG. 35 as being to the left. The movement of the pushing member 602′ will also move the urging member 606 to the left and may travel until the pushing member 602′ is in contact with the bell housing 476′, as depicted in FIG. 35. Movement of the urging member 606 in a direction, for example, as depicted towards the left, will cause the plungers 608 to travel laterally over the surface of the driveshaft 474, and will place the plungers 608 in a position bearing down against the left side bearing surface 484 of the driveshaft 474. Assuming that the clutch assembly 500 is in a position that allows the driveshaft 474 to be capable of laterally shifting, collective pressure from each of the plungers 608 of the urging assembly 606 would bear down on the left bearing surface 484, and urging the driveshaft 474 to shift to the right as the plungers 608 ride down the bearing surface, until the drive shaft is fully shifted, characterized by the plungers being positioned at the transition point on the driveshaft 474 where the bearing surface 484 transitions to the nominal driveshaft diameter 475, as depicted in FIG. 35, and in axial cross-section view in FIG. 38.

In this manner, the pushing member 602′ can be caused to reciprocate within the bell housing 476′, with the movement of the pushing member 602′ selectively being controlled by a user directing the movement of pressurized fluid into the respective chambers 652,654.

Similar to the manner described before with regard to the locking assembly 600, the urging member 606 of the locking assembly 600′ would be caused to move and apply and urging force to each of the respective bearing surfaces 484. Thus, with regard to the FIG. 36, the urging member 606 is positioned with the plungers 608 bearing down on the right side bearing surface 484, to urge the driveshaft 474 to shift laterally to the left, in order to cause the engagement of the clutch assembly 500 when the lateral shifting is possible. Similarly, with regard to the FIG. 35, the urging member 606 is positioned with the plungers 608 bearing down on the left side bearing surface 484, to urge the driveshaft 474 to shift laterally to the right, in order to cause the disengagement of the clutch assembly 500 when the lateral shifting is possible.

Further aspects concerning the movement and operation of the locking assembly 600 and 600′ will be described. As the urging member 606 is shifted by the respective pushing member 602, 602′, the urging member will pass over the annular protrusion 480, such that the plungers 608 would be forced outwards and at least partly into the recess openings 640 in the collar 607, compressing the biasing devices 610, as the plungers 608 are caused to ride up one of the ramped bearing surfaces 484.

As noted previously with regard to the locking assembly 600, the urging force applied by the urging member 606 of the locking assembly 600′, when the pushing member 602′ is reciprocated to have the urging member 606 selectively positioned on either side of the apex 482 of the annular protrusion 480 of the driveshaft 474 applies merely an urging force to the driveshaft. Actual shifting movement of the driveshaft 474 will not occur until the necessary conditions previously described are met for engagement or disengagement of the clutch assembly 500, thus the urging force of urging member 606, regardless of mode of control of the locking assembly 600, 600′ remains subservient to the necessary conditions of the clutch components 502, 504 that are determinative of when the application of the urging upon the driveshaft 474 will become effective. Thus, the teachings regarding the performance of the locking assembly 600 are similarly applicable to the performance of the locking assembly 600′, with one distinction being the manner of controlling the pushing member 602, 602′, and aspects related to carry out the movement of the pushing member.

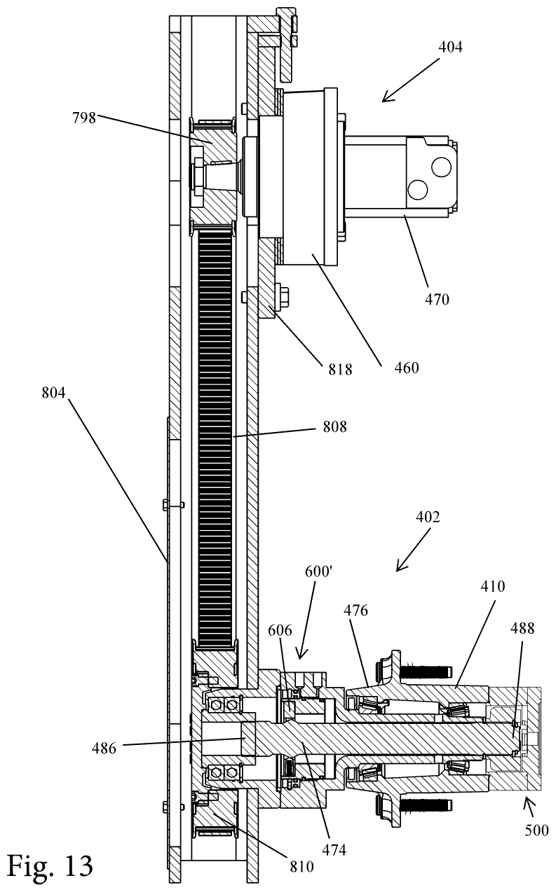

Details of an exemplary front wheel assembly 400 can be seen with reference to the FIGS. 11 and 12, as well as to the cross-section view of FIG. 13. As shown, there is provided a motor 470 that can be operated to cause the rotation of a driveshaft 474. The driveshaft is capable of being urged to shift laterally along its longitudinal axis using an embodiment of the locking assembly 600, 600′ as described herein. As before, lateral shifting of the driveshaft 474, at the urging of the locking assembly 600, 600′, will cause the clutch assembly 500 to selectively engage or disengage, in order transmit power from the motor 470 through the driveshaft 474 and clutch assembly 500 to cause the powered rotation of the front wheels 52, or alternatively, when the clutch assembly 500 remains disengaged, to allow the front wheels to freewheel, as previously described. With reference to FIGS. 11-12, the motor 470 and optional transmission 460 of a motor power source 404 may be mounted to a portion of the frame 2, such as the forward protruding wheel support plates 98, optionally via a mounting plate 818 that is secured to the wheel support plate 98, and is capable of being positionally adjusted by an adjustment mechanism 820, such as may be useful for achieving proper belt 808 tension. Additionally, an optional belt guard 804 which may be integrally formed where the wheel support plate 98 is provided as a hollow beam, and may be provided over the belt drive mechanism. It is contemplated that where the wheel support plate 98 is instead a rigid plate member, and not a hollow beam as shown, a belt guard may be secured to the wheel support plate 98 as a cover portion mounted to the wheel support plate to at least partially enclose the belt drive mechanism. The motor 470 and transmission 460, if present, are then mounted to the wheel support plate 98, and mechanically linked to the rest of the drive components, for example, by the providing of a belt drive mechanism, shown in detail in the exploded view of FIG. 12, as well as the cross-section view of FIG. 13. As illustrated, the belt 808 is routed around a motor pulley 798 driven by the motor 470, optionally through a transmission 460. The belt 808 is also routed around a power input pulley 810 that is secured to the power input end 486 of the driveshaft 474, such that the driveshaft is capable of sliding laterally relative to the pully 810. The belt 808 may optionally be provided within a protective barrier, such as the belt guard 804, as is visible in FIGS. 6 and 12. In an embodiment, the belt guard 804 is an integral part of the wheel support plate 98, as shown. The driveshaft 474, with the annular protrusion 480 is as previously described and is extended through the locking mechanism 600, 600′, such that the urging member 606 within the locking mechanism may apply a selective urging force upon the driveshaft, such that it may be urged to shift laterally along its longitudinal axis, as taught previously, with the urging force applied by the locking mechanism 600, 600′ being merely an urging force directed by the controlled operation of the locking mechanism 600, 600', in order to engage or disengage the clutch assembly 500, subject to the clutch assembly 500 components allowing the urging force to become effective, in the manner previously described.

Further details regarding the driveline of the front wheel assembly 400 can be seen with reference to the partial cross-section view of FIG. 13, and the exploded part view of FIG. 12. As depicted, the driveline is powered by a motor 470 that drives a motor pulley 798. The rotation force from the motor driveshaft may optionally pass through a transmission 460, such as a planetary gearset, or other arrangement as will be familiar to those of skill in the art for varying the input torque and the output torque, in order to adjust the rate of rotation and torque provided by the motor 470 as delivered to the front wheels. The motor pulley 798 is affixed to, and therefore driven by the output shaft of either the motor 470 directly, or the transmission 460, if present, as shown. A belt 808 is passed around the motor pulley 798, and also around the power input pulley 810. The splines of the power input end 486 of the driveshaft 474 allow the driveshaft to be rotationally fixed to, and remain slidingly engaged with, the power input pulley 810. The driveshaft 474 passes through a previously described locking assembly 600, 600′, as shown, in an exemplary embodiment, the locking assembly may be the hydraulically operated embodiment of the locking mechanism 600′. The power output end 488 of the driveshaft 474 is fixed to the driven clutch component 502 of the clutch assembly 500. While the pressure actuated locking assembly 600′ is depicted, it is contemplated that the manually operated locking assembly 600, relying on a handle or knob to control the locking assembly 600 may be provided as an alternative embodiment. Operation of the locking assembly, whether 600 or 600′ is as previously described in order to urge the driveshaft 474 laterally to engage or disengage the clutch assembly 500, when the components 502, 504 allow the shifting of the driveshaft.

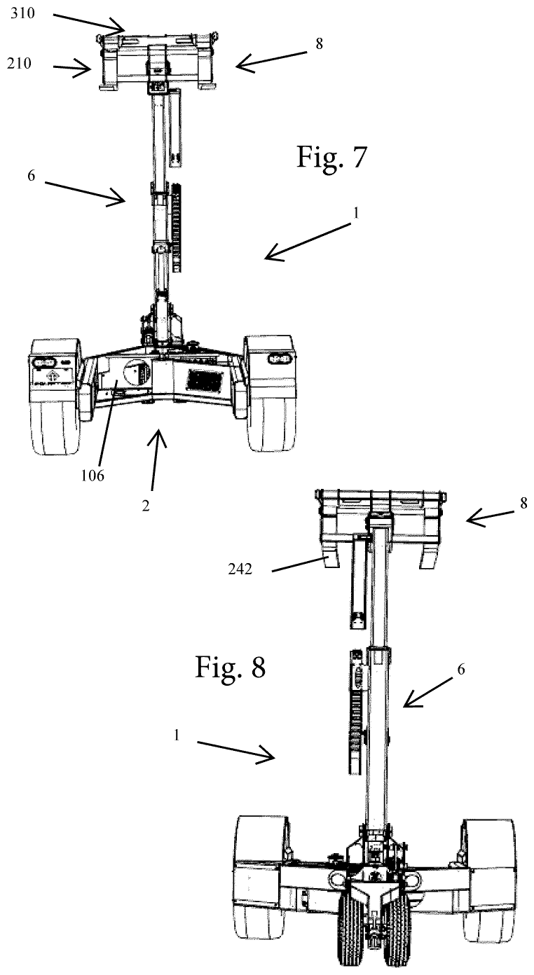

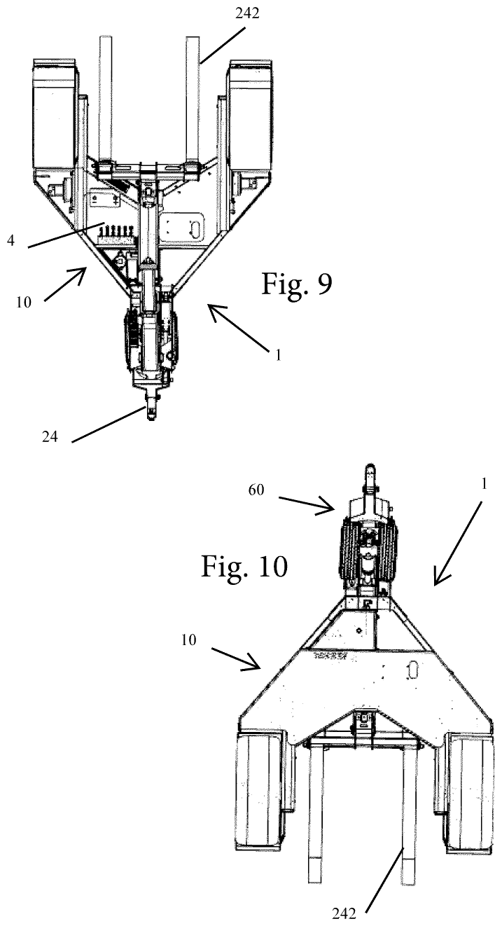

With reference to FIGS. 1-10, depicting the forklift assembly 1, in an exemplary embodiment, the drive assembly 4 generally has a movement system assembly 110. The movement system assembly 110 generally has a control system 112 and a motor assembly (not shown) which may be a conventional internal combustion engine powering a hydraulic pump that may be fitted into the motor assembly compartment 114 as shown in FIG. 1. Alternatively, a plurality of batteries and an electric motor to operate a pump may be provided within the motor assembly compartment 114.

The control system 112 includes a plurality of controls which may be a series of wires, hydraulic pressure distribution manifold, valves and electronics for suitable controls to allow the operator to control the forklift assembly 1. The control system 112 therefore provides the operator with the ability to control all, or many of the features of the forklift assembly 1 from a different location by remote control. The control system 112 may further include a plurality of sensors S distributed through the forklift assembly 1. The one or more sensors may be distributed on the frame 2 and the extension assembly 6 and may monitor and provide information on a sensed condition to the control system. In an embodiment, the control system 112 allows the forklift assembly 1 to have operating aspects selectively directed, for example, in order to selectively disengage and engage the drive system of the front wheel assemblies 400, and thereby provide system control in providing the forklift assembly 1 in a configuration to travel under its own power or be placed in a condition for towed operation. Such a sensor(s) may monitor the stem 78 at the pivot mount and assess if the rear wheel assembly 80 is bearing the weight of the forklift assembly 1, or monitor the position of the tow hitch to determine if the rear wheel assembly 80 has been lifted clear of the ground surface, such as by operation of the tow hitch actuator 22 to pivot the articulating tow hitch 24, such that the rear wheel assembly 80 may be caused to not be bearing any weight.

In an exemplary embodiment, a first sensor S may be provided associated with the rear wheel assembly 80, where the sensor is configured to monitor if the rear wheel assembly is weight bearing or is not weight bearing. Such a sensor may be positioned to monitor the end of the stem 78 closest to the pivot mount. The sensor would then detect and provide the sensed condition information to the control system as to whether the rear wheel assembly 80 is bearing the weight of the forklift assembly 1, or if the rear wheel assembly 80 has been lifted clear of the ground surface, such as by operation of the articulating tow hitch 24, such that the rear wheel assembly 80 is not bearing any weight. In an embodiment, the first sensor is a pressure sensor, such as a position switch, that detects a small upwards movement of the rear wheel assembly 80 when it is bearing at least some of the weight of the forklift assembly 1. With the rear wheel assembly 80 not bearing any weight, the sensor would detect the non-weight bearing condition, and provide the condition information to the control system 112.

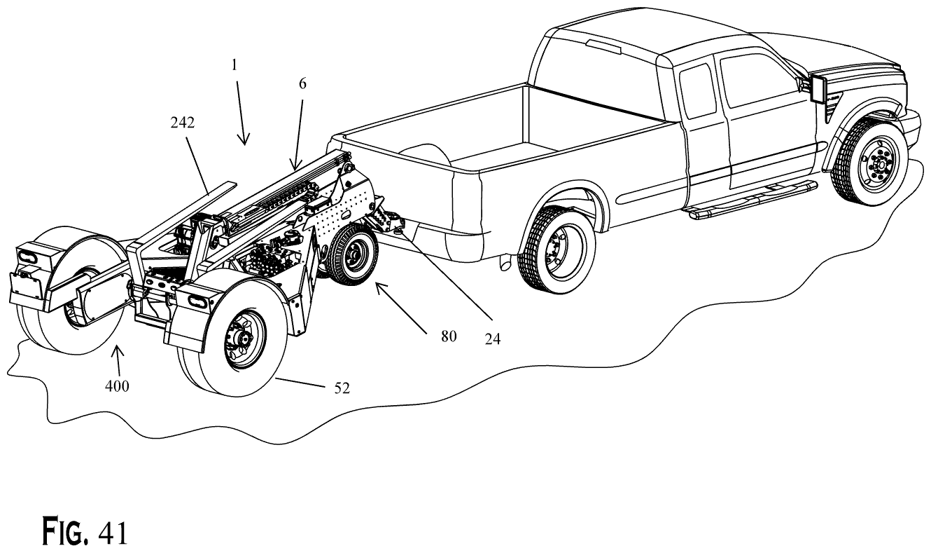

Additionally, a second sensor S may be provided to monitor the position of the articulating tow hitch 24. The second sensor S may be secured to the rear support assembly 60, and detect when the articulating tow hitch 24 is pivoted within its range of travel past a set point, whether to position the ball hitch receiver end downwards relative to the frame 2 and caused to lift the rear wheel assembly 80, or when the articulating tow hitch is pivoted upwards relative to the frame 2 and caused to lower the rear wheel assembly 80. With the articulating tow hitch positioned to engage the ball hitch receiver end on a ball hitch of a tow vehicle, and the articulating tow hitch actuated, the rear wheel assembly 80 may be lifted clear of the ground in a desired amount for towing operation of the trailer, as can be seen with reference to FIGS. 41 and 43. In an embodiment, the second pressure sensor is a pressure sensor, such as a position switch, that detects the articulating tow hitch 24 pressing against the sensor when pivoted upwards past a threshold detection setpoint, relative to the frame 2, and if the articulating tow hitch is pivoted downwards by the tow hitch actuator, the second sensor would detect the articulating tow hitch travelling past and below the threshold point, and detect an absence of pressure against the sensor.

In turn, the control system 112, upon receiving desired sensor conditions for the first and second sensors, would then enable the operation of the locking assembly 600, 600′ in order to urge the dis-engagement of the clutch assembly 500. In an embodiment, the control system 112 may direct the release of the brake assembly for each of the front wheel assemblies 400, when the conditions towed operation are met, as determined by the sensors as discussed previously. Receiving the sensor information for the rear wheel assembly and tow hitch position thus allows the control system 112 to serve as a check, and ensures the safety of allowing the disengagement of the clutch assembly 500 of each of the front wheel assemblies 400 when allowed to proceed only when the rear wheel assembly 80 is confirmed to be non-weight bearing, as detected by the first sensor S, and the articulating tow hitch 24 has been moved to a position such that the rear wheel assembly 80 will be lifted clear of the ground surface by at least the desired amount, as detected by the second Sensor S monitoring the position of the tow hitch 24. In this manner, the control system 112 will receive the sensed information, and recognize the necessary conditions are met, specifically, that the forklift assembly 1 is properly hitched to tow-vehicle with the rear wheel assembly 80 raised clear of impacting the ground surface when being towed, and thus the conditions for the forklift assembly 1 are safe to allow towing operation of the forklift assembly 1, by allowing the disengagement of the drive lines for the front wheel assemblies, and may further direct the release of the braking system, if present, to allow free-wheeling operation of the front wheels.

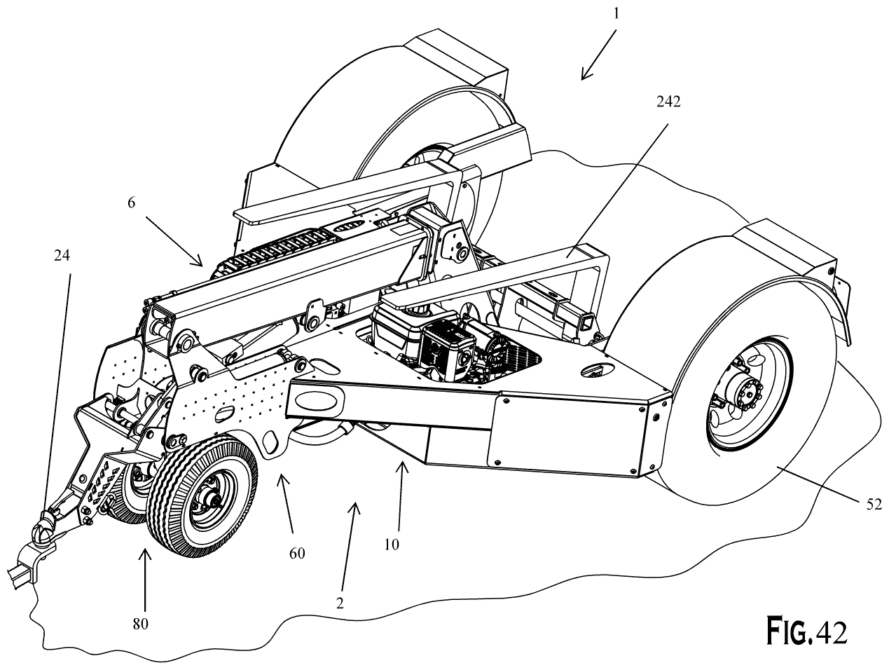

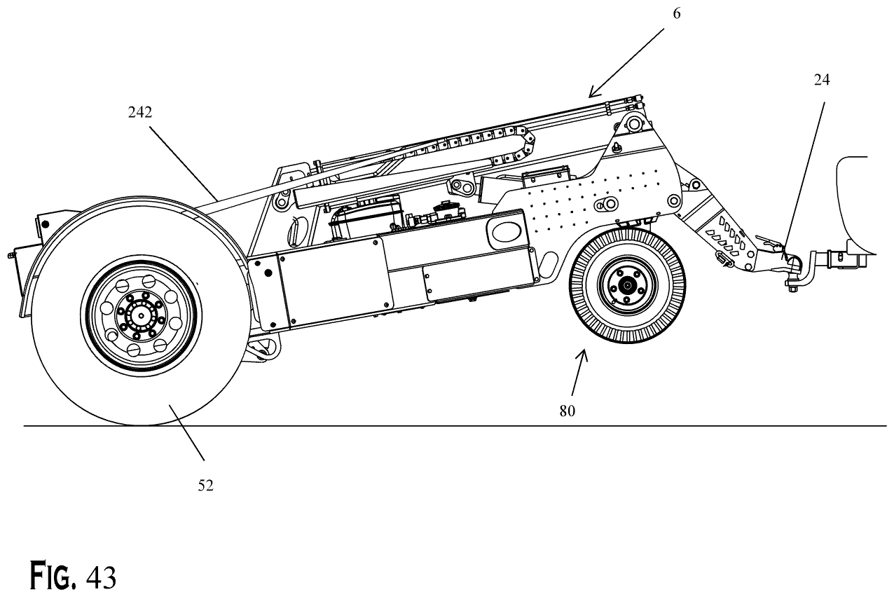

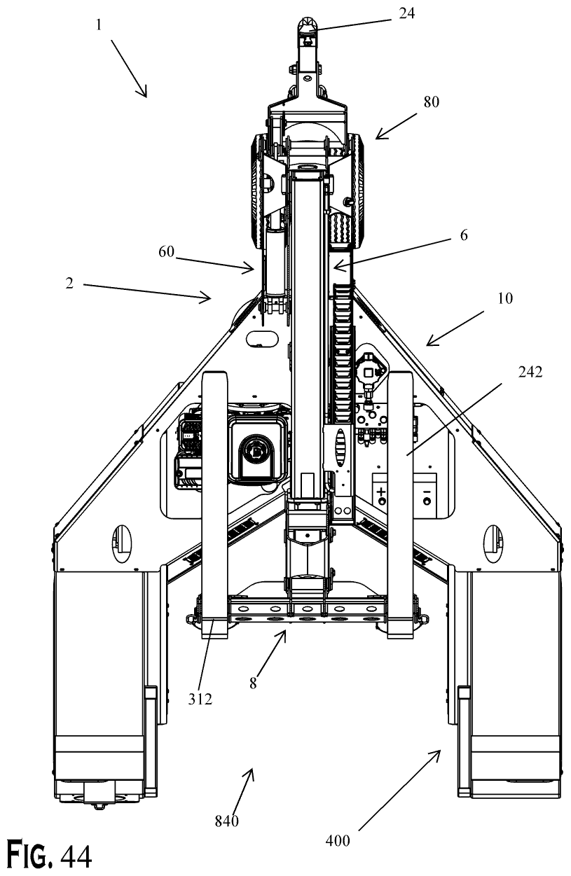

As depicted in FIGS. 41 and 43, the forklift assembly 1 is shown secured to a tow vehicle, with the articulating tow hitch pivoted downwards, in order to raise the rear wheel assembly 80 clear of the ground. In such a condition, the driveline assembly for powering the drive wheels is to be disengaged to allow towed operation. Furthermore, the extension assembly 6 is generally retracted, and lowered such that it is positioned in a resting position, immediately above the frame 2, and the carrier assembly 8 is positioned with the prong assembly 240 having been rotated to initially pivot upwards, and then continued rotation to point the prongs towards the tow hitch, in order to provide the carrier assembly 8, and each of the protruding fork prongs 242 in a compact stowed position, as shown in FIGS. 42, 43, and 44. The linch pins 312 may be removed to allow the prong members to be urged into the compact stowed position, and then returned to maintain the desired configuration of the prong assembly 240 during towing operation of the forklift assembly 1. Removal of the linch pins 312 would allow the prong assembly 240 to be returned to the initial position depicted in FIG. 40. In another embodiment, the carrier assembly 8 may be rotated through approximately 180 degrees from the typical deployed position, as depicted in FIG. 1, to provide the ends of the prongs 242 pointing generally towards the tow hitch 24 end of the forklift assembly 1. In the stowed position, as can be seen with reference to FIG. 44, the prong members 242 are generally positioned alongside and/or parallel to the lowered and retracted extension assembly 6. While the fork prongs are depicted being nearly parallel, it is contemplated that some extent of angular deviation from parallel, relative to the top plate of the frame is acceptable, and as utilized herein, the fork prongs being nearly parallel to the frame would include up to 30 degrees of deviation from parallel to the top plate of the frame. While maintained in the compact stowed position, the forklift assembly 1 is configured to minimize the physical dimensions of the assembly, such that the forklift assembly 1 is configured in a manner that is optimized for towing by a tow vehicle, as depicted in FIG. 41.

The motor assembly compartment 114 is provided to house components of a motor assembly, as will be familiar to those of skill in the art. A suitable motor assembly generally includes a motor, a motor drive mechanism, and a motor housing. The motor may be any suitable source of power, such as an electrically driven motor, or an internal combustion engine with operation controlled by the control system 112. The motor may provide pressurized fluid through the control system 112 for controlling the operation of a plurality of actuators of the forklift assembly 1, and to the drive motors 474 for the wheel assemblies, using hydraulic lines (not shown). The motor assembly may be at least partially contained within the motor assembly compartment 114. In an embodiment, a motor may power on onboard pump to generate the hydraulic power to be distributed through the manifold at the direction of the controls to operate the actuators and the driveline motors for each of the drive wheels, as taught herein. In another embodiment, the linear actuators provided for the forklift assembly 1 may be electronically operated linear actuators, with power for driving the linear actuators being provided by onboard battery power, or by a motor driven generator to provide working power.

In an exemplary embodiment, the forklift assembly 1 may be provided with a power source (not shown) such as a combustion engine to operate a fluid pump and provide hydraulic pressure, as will be familiar to those of skill in the art. The fluid pressure within the hydraulic system may then be selectively delivered to components of the forklift assembly 1, in order to power the movement of the forklift assembly 1 by operation of one or more of the motors 470 of the front wheel assemblies 400, as well as to operate the lifting and extension of the extension assembly 6 and operation of the carrier assembly 8, along with any other actuators provided. The lifting and extension assembly 6 uses one or more actuators to raise and extend the lifting boom, and as shown, can adjust the angle of the head portion bearing the fork ends, such as can be used for moving loads, such as pallets, or other items as will be familiar to those of skill in the art. It is recognized that alternative lifting and extension mechanisms may be substituted for the embodiment depicted, such that the trailer can be engaged in self-propelled movement and towed movement as previously described. It is thus, recognized that the teachings of the clutch assembly 500, and the locking mechanism 600, 600′ may be employed in any variety of vehicles, and need not be limited only to the exemplary forklift assembly 1 vehicle shown herein, where there is a need for allowing the controlled engagement and disengagement of the drivelines, using a locking assembly 600, 600′, for one or more of the wheel assemblies 400, such as may be useful for transitioning the vehicle between a self-propelled mode, where a clutch assembly 500 would desirably be engaged to allow controlled movement of the vehicle, and a towed operation mode where a clutch assembly 500 would desirably be disengaged to allow safe towing of the vehicle, and the driveline would remain disengaged while being towed.

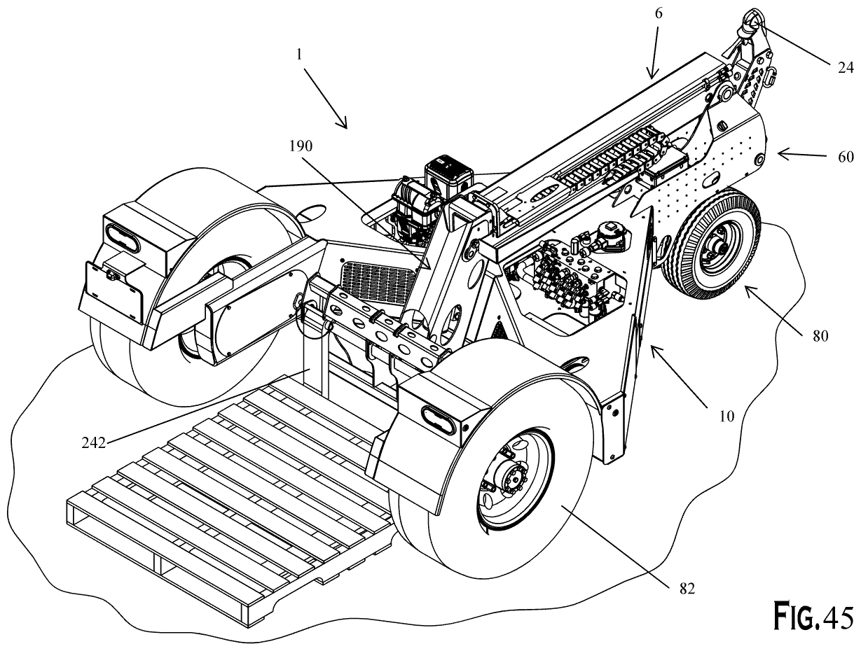

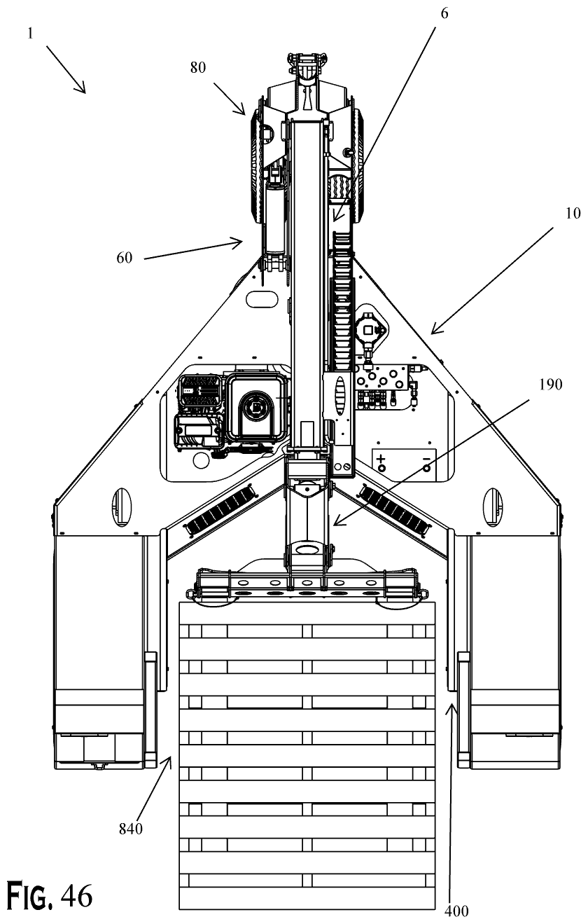

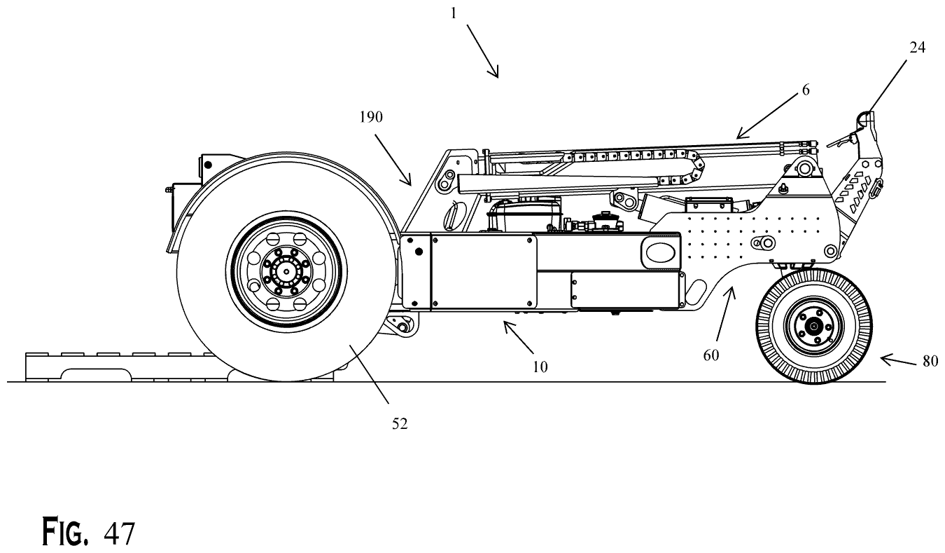

In an embodiment, and with reference to FIGS. 45, 46 and 47, the forklift assembly 1 is depicted carrying a representative load, such as an exemplary pallet as shown, which may further bear equipment or materials thereon, as will be familiar to those of skill in the art, and as shown in phantom lines in FIG. 1. Referring to FIGS. 45-47, a load, such as the pallet shown, may be supported by the carrier assembly 8, by placing the forklift prongs into a supporting position (e.g., into the representative pallet), and for maximum stability during self-propelled movement of the towable self-propelled forklift assembly 1, may provide the load being positioned close to, but not in contact with the ground level, and with the load urged generally rearwards, for example, by providing the sliding mechanism 160 generally retracted to the extent possible while bearing the load, and the raising mechanism 170 nearly in a fully lowered position. As depicted, the carrier assembly 8 would be then positioned near the leading faces 106 of the front support assembly 10, such that the forklift prongs 242 with the load are at least partially received in a carriage receiving opening provided between the drive wheels 52. Collectively, the leading faces 106 of the front support assembly 10, and the inward facing sides of each of the wheel assemblies 400 form a carriage receiving assembly 840, which defines the boundaries of the carriage receiving opening in which the carrier assembly 8 may be positioned, as depicted in FIGS. 45-47. In an embodiment, some portion of the carrier assembly 8 may protrude forward from the carriage receiving assembly, such as the protruding portion of each of the prong members 242. Picking up, or dropping off, a load can be achieved in any manner that will be recognized by those of ordinary skill in the art, requiring controllably positioning the prong members 242, and adjusting the height and/or tilt of the prong members 242, by controllably moving the carriage assembly 180, and or the extension assembly 6. As shown in FIG. 47, to facilitate loading, for example, the forklift prong members 242 may be lowered close to ground level, and directed into openings of a pallet, as is known with other forklifts and as will be familiar to those of skill in the art; and then the carrier assembly 8 may be slightly raised, to clear the pallet from contact with the ground surface, and the forklift assembly 1 may then be driven as taught herein, in order to move the load or pallet to another location. The operation may be reversed to remove the load from the prong members 242. With the prong members 242 carrying a load, as depicted in FIG. 47, and the carrier assembly 8 positioned within the carriage receiving assembly 840, a majority of the load would be maintained within the footprint of the forklift assembly 1, defined by the position of the front wheels 52 and the rear wheel(s) of the rear wheel assembly 80. Necessarily then, with the forklift assembly configured as depicted in FIGS. 45-47, and carrying a load, the center of gravity for such a loaded forklift assembly 1 would be maintained between the front wheels 52 and the rear wheel assembly 80, i.e., within the footprint of the forklift assembly 1. In an embodiment, a majority of the load borne by the prong members 42 would be positioned within the footprint of the forklift assembly.

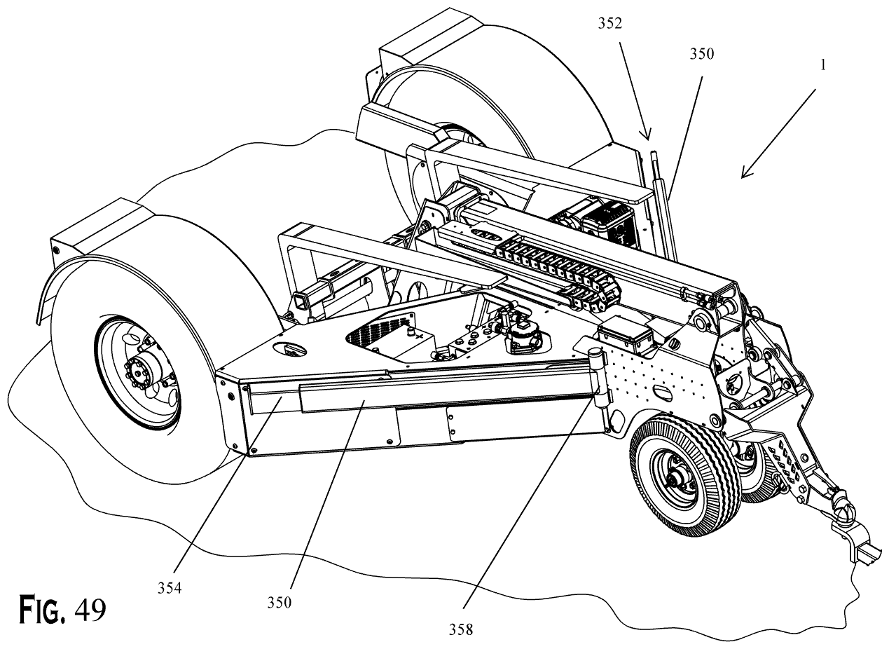

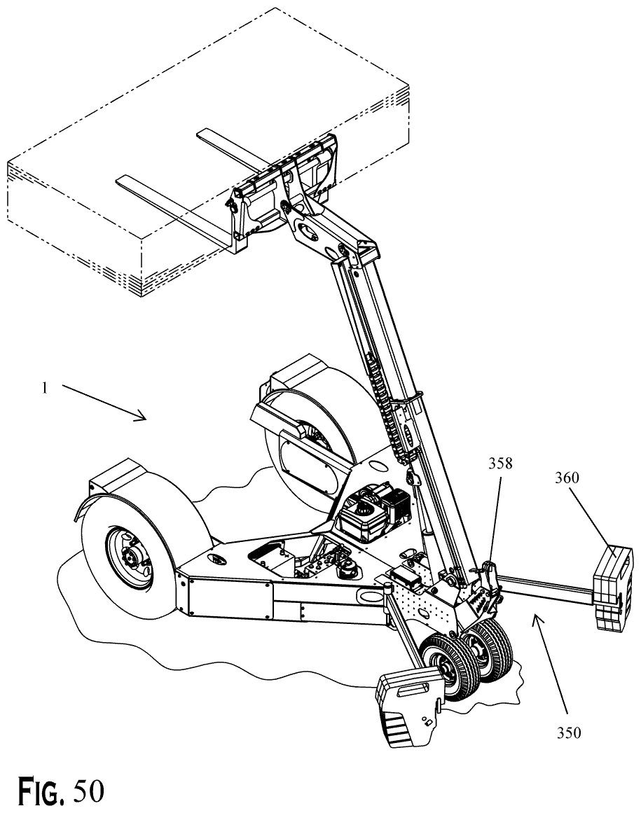

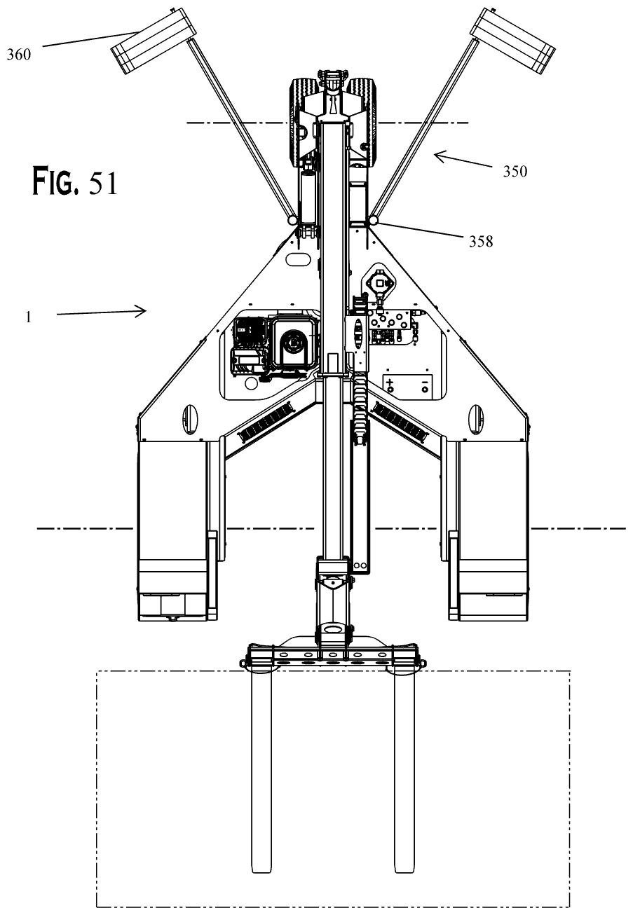

In an exemplary embodiment, the forklift assembly 1 may further be provided with one or more repositionable counterbalance arms 350. As shown in FIGS. 49, 50 and 51, the forklift assembly 1 may be provided with a pair of counterbalance arms 350, each pivotably mounted near the mid-point of the forklift assembly 1 and positioned on either side. As shown, each counterbalance arm 350 has a free end 352 terminating adjacent to a weight receiving region 354, depicted here as a receiver bracket upon which one or more weights 360 may be added, and configured to be securely retained in the weight receiving region 354. The other end of each counterbalance arm 350 terminates at a pivot mount 358 through which the counterbalance arm is pivotably secured to the frame 2 of the forklift assembly 1. The pivot mount 358 may be a hinge portion, with a securing pin holding the arm 350 to a receiving hinge portion on the frame. The counterbalance arms 350 may be pivoted between a stowed position (of FIG. 49) and a deployed position (of FIGS. 50 and 51). The stowed position, as depicted in FIG. 49, is characterized by the counterbalance arms 350 being compactly positioned alongside the front support frame, with the free end 352 positioned generally near the drive wheels 52, and the length of the counterbalance arms 350 being positioned alongside the front support assembly 10. While in the stowed position, the weight receiving region 354 may be free from any weights. The counterbalance arms may be releasably secured in the stowed position by a detent in the pivot mount, or through the use of a locking mechanism to secure the arm in a stowed position, as will be familiar to those of skill in the art. The counterbalance arms 350, while in a deployed position, as depicted in FIGS. 50 and 51, would be oriented such that each of the counterbalance arms 350 are splayed out at an angle away from the pivot mount 358 on the frame 2, and extending towards the rear of the forklift assembly 1. The counterbalance arms 350 may be temporarily locked to remain in either the stowed, through any suitable locking mechanism, such as a detent in the pivot mount, or a locking component that can securely hold the position of the loaded counterbalance arms, even while the forklift assembly is navigating terrain while loaded. The counterbalance arms may be controllably released from being locked in a position, such that the user can direct or control the placement of the counterbalance arms 350 in one of a stowed position, and a deployed position, as selected by the user.

As can be seen with reference to FIG. 50, each of the counterbalance arms may receive one or more weights 360 thereon, which may be securely mounted to, or received in the weight receiving region 354 of the counterbalance arm 350. As shown, an exemplary weight 360 is provided in the form of a suitcase weight, as will be familiar to those of skill in the art. It is contemplated that any modular weight unit, capable of being secured or mounted to the weight receiving region of the arm may be suitably employed. It is contemplated that a weight unit may be provided in one of a selection of different weights as appropriate, such that the user has flexibility in deciding which weights 360 to select as being appropriate for counterbalancing a loaded forklift assembly 1. In an embodiment, the suitcase weight has a handle, and a mount, such that each weight could be conveniently carried by a user, and mounted temporarily on to the weight receiving region 354 of the counterbalance arm 350. The weights 360, when not mounted to the counterbalance arms 350, may be stored elsewhere on the forklift assembly 1, e.g., secured to the frame 2, or alternatively, stored away from the forklift assembly 1, such as in the tow vehicle.

The counterbalance arms 350, while in a deployed position, will serve to shift the center of gravity for the forklift assembly 1 somewhat rearwards, such that the forklift prongs, when loaded as depicted in FIGS. 50 and 51, would be balanced by weights 360 suspended on the ends of the counterbalance arms 350, when deployed, and angled outwards from the pivot mount 358 and extending towards the rear of the forklift assembly 1, as shown.

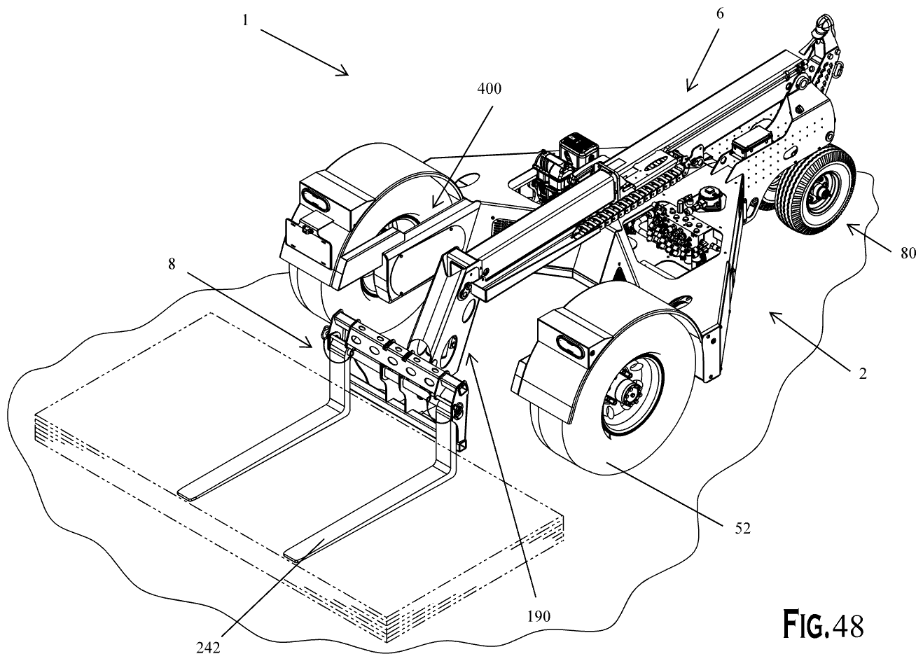

In an embodiment where the load to be received upon the carrier assembly 8 is of dimensions such that it is incapable of being fitting between the drive wheels 52 when the extension assembly 6 is provided in a lowered position, such as with the exemplary load provided as board shaped materials (e.g. standard sized sheets of plywood, or drywall); such a larger load may be first lifted, and carried in the position depicted in FIG. 48, where the carrier assembly 8 may be advanced forwards from the frame, by extending the sliding mechanism 160, in a manner that is similar to operation of telehandlers. In such an instance, the carried load may be positioned at or near ground level, and slightly forward from the drive wheels.

In any of the embodiments, the load may be maneuvered or positioned, using the various actuators of the extension assembly, as well as by controllably moving the forklift assembly, in order to position the load at a desired location, as will be familiar to those of skill in the art.

With reference to FIG. 17, with portions of the forklift assembly 1 removed for clarity, the articulating tow hitch 24 and operation will be described. At the rear most portion of the rear support assembly 60, the through holes 276, 62 are provided through each of the respective plates 118, such that a fastener can be directed therethrough to secure and provide a pivoting mount for a first end of the articulating tow hitch 24 having corresponding through holes to receive the fastener. With a fastener in place through the through hole 276, the tow hitch will be pivotably secured to the rear support assembly 60 as shown. The second end of the articulating tow hitch 24 is a component that can receive a towing implement, such as a ball receiver. The first end of the articulating tow hitch 24 may be provided with a pair of projecting arms 26, each configured to be movably fitted into a space between the inner plate 292 and outer plate 294 of the rear support assembly 60, each arm 26 having a through hole for receiving the fastener for securing the tow hitch assembly to the rear support assembly 60. In an embodiment, the pair of projecting arms 26 are spaced to abut directly against the outer plates 294, and thereby the tow hitch may further serve as bracing to strengthen the rear support assembly 60 to resist stresses applied. Additionally, near the top of at least one arm 26, there a first end of a linkage arm 28 is pivotably secured thereto. The second end of the linkage arm is pivotably secured to a swing arm 30. The swing arm provides three attachment points, as such, the swing arm may be provided in a generally triangular shape. At the rear most portion of the swing arm, the swing arm is pivotably connected to the linkage arm 28. The swing arm is also connected to the extensible end 21 of the tow hitch actuator 22. At the top of the swing arm 30, the swing arm is pivotably secured to one of the inner plates 292 and the adjacent outer plates 294 by a fastener directed through fifth through hole 284, 70 of the respective inner and outer plates 292, 294.

The articulation of the tow hitch is provided by controllably moving the tow hitch actuator 22 using the control system 112. The tow hitch actuator 22 is an actuator which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure.

The tow hitch actuator 22, as shown, is secured to the rear support assembly 60 providing a fixed location for the first end of the tow hitch actuator 22. The tow hitch actuator has an extensible end 21 that is secured at a second end of the actuator 22 to the swing arm 30. Extension or retraction of the tow hitch actuator 22 will cause the swing arm to pivot about the pivot point at the top portion of the swing arm. The pivoting swing arm 30 will cause the pivoting movement of the tow hitch 24, due to the connection to linkage arm 28. Thus, the extension of the actuator 22 will result in the ball receiver end of the tow hitch to be urged lower, relative to the rear support assembly 60. Conversely, retraction of the actuator 22 will result in the ball receiver end of the tow hitch to be urged higher, relative to the rear support assembly 60. In this manner, the operation of the tow hitch actuator 22 may be controlled, such that when the ball hitch receiver is secured to a tow ball of a tow vehicle, extension of the tow hitch actuator will result in the ball hitch receiver being urged downwards, and as the weight of the forklift assembly 1 is taken on by the hitch, the rear wheel of the rear support assembly 60 would be caused to be raised off the ground, such that the forklift assembly 1, with the drivelines of the front wheels disengaged, and the rear wheel lifted clear from impacting the ground, may be safely towed without damage to the driveline.

Conversely, retraction of the tow hitch actuator 22 will raise the ball receive end of the tow hitch 24, relative to the frame 2 of the forklift assembly, until the rear wheel assembly 80 bears the weight of the forklift assembly, and the ball receiver end of the tow hitch 24 is lifted clear of the tow vehicle. In this manner, the forklift assembly 1 may have the drivelines 402 engaged and may be maneuvered under self-propelled movement, with the rear wheel 82 resting on the ground. To return to towed operation of the forklift assembly, the forklift assembly may be maneuvered to place the tow hitch ball receiver above the tow ball of the tow vehicle, and the actuator 22 extended to rotate the tow hitch downwards and engage the towing components. Once the tow hitch is hitched up to the tow vehicle, the tow hitch actuator 22 may be further extended, at least to the point that the rear wheel 82 is raised clear from contact with the ground surface, such that the rear wheel will not impact towing operation of the forklift assembly 1. The drivelines 402 of the front wheel assemblies 400 should then be urged to disengage. With the weight of the forklift assembly 1 supported by the tow vehicle, the urging force of the locking assembly 600′, 600 may become effective to place the drivelines into freewheeling mode for safe towing.

Once the forklift assembly 1 is towed to a work site, with the rear wheel 82 off the ground, actuation of the tow hitch actuator 22 causing the retraction of the piston into the barrel and shortening the distance between the swing arm and fixed mount of the actuator, will cause the tow hitch 24 to pivot upwards, and if remaining hitched to a tow vehicle, the actuator lifting the tow hitch relative to the frame 2, will allow the rear wheel to come into contact with the ground, and continued retraction of the actuator will result in the rear wheel becoming weight supporting and bearing the forklift assembly 1, to allow self-propelled operation independent of a tow vehicle. Prior to unhitching the forklift assembly 1 from the tow vehicle, care must be taken to ensure that brakes are applied to the vehicle, or the drivelines of the front wheel assemblies are urged to engage. Continued retraction of the actuator 22 would then allow the ball hitch receiver to be raised further, such that the forklift could be unhitched from the tow vehicle, and operated independently in a self-propelled manner, as discussed herein.

In an exemplary embodiment, and with reference to FIGS. 1-10, the extension assembly 6 generally has a boom support 140, a sliding support 150, a sliding mechanism 160 and a raising mechanism 170.

As illustrated in the cross-sectional view of FIG. 6, the boom support 140 is an elongated structural beam. The boom support 140 includes a sliding support receiving passageway 142. The boom support 140 further includes an actuator connector 144 positioned on an outer portion of the boom support 140. The boom support 140 further includes a rear frame connector 146.

The sliding support 150 is an elongated structural beam having an actuator receiving passageway 152 and extending the length of the sliding support 150. The actuator receiving passageway 152 is shaped to receive an actuator and, as shown, a cross section area of the sliding support receiving passageway 142 is larger than a cross section area of the sliding support 150. As a result, a leading end of the sliding support 150 is positioned through the sliding support receiving passageway 142.

The sliding mechanism 160 is an actuator which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure.

As shown in FIG. 6, the raising mechanism 170 provides an actuator which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure. One of ordinary skill in the art would understand the main components of a hydraulic cylinder.

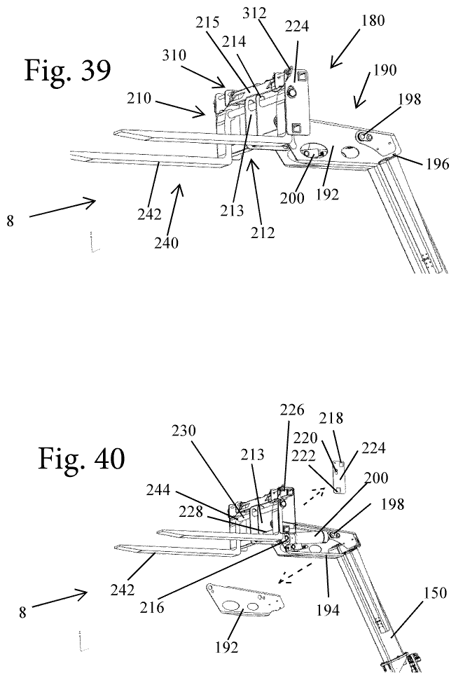

In the exemplary embodiment of FIGS. 39 and 40, the carrier assembly 8 generally has carriage assembly 180. The carriage assembly 180 generally has a knuckle rotation assembly 190, a carriage movement assembly 200, a back rest assembly 210, a prong assembly 240, and a locking assembly 310 as illustrated in FIGS. 5-8, 39-40.

The knuckle rotation assembly 190 includes pair of plate like knuckle members 192 and a knuckle bottom plate 194. The knuckle rotation assembly 190 further includes a plurality of fastener receiving passageways 196 positioned at an end and extending completely therethrough. The knuckle rotation assembly 190 further includes a first carriage actuator connector 198.

The carriage movement assembly 200 provides an actuator, which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure.

The back rest assembly 210 includes a mount 212. The mount is a pair of plate like members 213. The mount 212 further includes a plurality of fastener receivers 214 extending therethrough. The mount 212 further includes a second carriage actuator connector 216 as shown. The mount 212 further includes a plurality of indented grooves and slots positioned at a front portion of the mount 212 as illustrated in FIGS. 39-40. The plurality of indented grooves and slots generally include a top slot 218, a lower slot 220 and a bar slot 222. The mount 212 further provides a brace plate 215.

The back rest assembly 210 further includes a plurality of bars. The plurality of bars include a pair of outer side bars 224 as illustrated. Each outer side bar 224 is a plate like member. The plurality of bars further include a top bar 226. The top bar 226 is a rigid bar member, such as a square tube member. The plurality of bars further include a lower bar 228. The lower bar 228 is a rigid member, such as a square tube member.

The back rest assembly 210 further includes a rail 230 positioned below the top bar 226 and above the lower bar 228. In an embodiment, the rail 230 is a rod like member as illustrated.

The prong assembly 240 includes a pair of prolongated forks, the prong members 242 as illustrated. Each of the prongs 242 may be secured in any suitable fashion, such as by providing an upright portion of the prong with a rail receiver 244 positioned at a top portion of the prong 242.

One skilled in the art would understand the depicted design is not the exclusive embodiment.

In the exemplary embodiment, the locking assembly 310 generally includes a pair of removable linch pins 312 and at least one plate member provided as outer side bar 224. Each linch pin 312 may be releasably secured with a securement pin, such as a cotter pin or ring, that is directed through a securing opening near the end of each linch pin 312, brace plate 215, and an angled plate like side bar 224. With the linch pins 312 removed, adjustments to the back rest assembly 210 are possible, as may be needed to allow repositioning or removal of one or both of the prong members 242. For example, with the linch pins 312 removed, one or both of the prong members 242 may be rotated upwards, and caused to pivot where the rail receiver 244 of the respective prong is pivotably mounted over the rail 230. Continued pivoting of one or both of the prong members in a clockwise direction (for the perspective view of FIG. 40) would cause the upright portion of the prong member 242 to be received against the brace plate 215 and/or the top bar 226. With the prong members 242 folded up and now rotated into a generally reverse orientation from that depicted in FIG. 40, such that the prong members 242 are placed into the stowed position depicted in FIG. 44, the linch pin 312 may be fully reinserted through the outer side bar 224 and pass adjacent to the upright portion of the prong member 242, such that the upright portion of the prong member 242 is physically secured by the presence of the linch pin 312, and is unable to be rotated back to the original position, until such a time as the linch pin(s) 312 are again removed. So long as the linch pin 312 remains in place to secure the prong member 242 in the stowed position, as depicted in FIGS. 41-44, as the upright portion would be constrained from movement and held within a locking channel created by the respective outer side bar 224, and inside bracket portion provided on one of the back rest assembly 210 or the brace plate 215. The removable linch pins 312 thus can selectively secure the prong members 242 in the stowed position of FIG. 44, until such a time as there is a need to return the prong members 242 to the deployed position depicted in FIG. 40, for use as a forklift.

As illustrated in the figures, when assembled, the frame 2 of the forklift assembly 1 including the front support assembly 10 and rear support assembly 60 are provided as a rolling chassis, including the pair of front wheel assemblies 400 and associated driveline components, as well as the rear wheel assembly 80. The articulating tow hitch is secured to the rear end of the rear support assembly through the use of a fasteners directed through the plates 118, as shown in FIGS. 14-17. The tow hitch is also connected to the linkage arm, which is also connected to the swing arm. The swing arm is pivotably secured to one of the adjacent pairs of inner and outer plates, as well as the swing arm being secured to the tow hitch actuator, which when actuated would cause the swing arm to pivot, and the linkage arm would cause the hitch to be raised or lowered, relative to the rear support assembly. The sliding mechanism 160 is positioned within the actuator receiving passageway 152 of the sliding support 150. The sliding support 150 is positioned within the sliding support receiving passageway 142. The sliding mechanism 160 is fastened to the sliding support 150 and the boom support 140, such that actuation of the sliding mechanism will cause the sliding support to telescope out from and retract into the boom support as the actuation of the sliding mechanism is reciprocated. At an opposite end from the sliding support 150, the boom support 140 is positioned within the pair of inner plate members 292, each supported by an adjacent outer plate members 294 providing a buttress portion, and the boom support is coupled by the rear frame connector 146, which may be a fastener or hinge pin member, directed through, from one side to the other, at least, a first outer plate member, a first inner plate member, the boom support 140, a second inner plate member, a second outer plate member. To facilitate pivoting movement of the boom support within the rear support assembly, one or more washers may be provided to space the inner plate members from directly contacting the boom support. The rear frame connector 146 may be retained in place by being secured by any suitable method known in the art, including through the use of retaining pins or bolts directed through the rear frame connector, or other suitable fasteners as will be familiar to those of skill in the art, such that the rear frame connector is unable to slide laterally out from the boom support unintentionally.

As illustrated in FIGS. 1-10, the raising mechanism 170 is coupled at one end to the actuator connector 144 of the boom support 140 and coupled at a second end and positioned within the inner plate members 292, secured by a fastener directed through the third through hole 280 to pivotably secure the second end of the raising mechanism relative to the frame 2. The raising mechanism 170 is positioned below the boom support 140. As the actuator of the raising mechanism 170 is caused to reciprocate, the lower boom will be caused to pivot and raise or lower the extension assembly 6. In an embodiment, the raising mechanism 170 is to be aligned along the longitudinal centerline of the forklift assembly 1, so as to maintain the center of gravity as close to the centerline of the forklift as possible.

The knuckle rotation assembly 190 is provided at the end of the boom support 140 away from the rear frame connector 146. The pair of plate like knuckle members 192 are coupled together. The knuckle bottom plate 194 is coupled to a rear of the plate like knuckle members 192. The plate like members of the mount 212 are mechanically fastened together. The top bar 226 is positioned within the top slot 218. The lower bar 228 is positioned within the lower slot 220. The rail 230 is positioned within the bar slot 222. The rail 230 is threaded through the rail receiver 244 of the prolongated plate like side bars 224. The pair of outer side bars 224 are positioned at each end of the top bar 226, lower bar 228 and the rail 230. Each retractable linch pin 312 is positioned at each end of the side bar 224 adjacent to the top bar 226 wherein the locking assembly 310 is positioned in front of the top bar 226 and facing inwards.

The actuator for the carriage movement assembly 200 is coupled at one end to the first carriage actuator connector 198 and coupled at a second end to the second carriage actuator connector 216.

A rear end of the knuckle rotation assembly 190 is connected to the sliding support 150 by the plurality of fastener receiving passageways 196.

The operator has the ability to control a plurality of movements for the forklift assembly 1 using the control system to actuate any of the actuators of the forklift assembly, and operation of drive assemblies of the front wheel assemblies.

The height of the forklift assembly 1 can be stretched and retracted by the raising mechanism 170. The raising mechanism 170 moves the boom support 140 to controllably vary the height of the boom support, by pivoting the boom support about the rear frame connector 146. Additionally, actuation of the extension actuator of the sliding mechanism will allow the control to adjust the effective length of the boom assembly, as the sliding support 150 is caused to telescope in or out from the boom support 140, to adjust the reach of the forklift assembly 1.

The knuckle rotation assembly 190 can be rotated in a clockwise direction and a counterclockwise direction by the carriage movement assembly 200 moving the mount 212 of the back rest assembly 210 in a first rotation direction and a second rotation direction as the actuator for the carriage movement assembly 200 is extended or retracted, to control the pitch of the extended fork elements.

Additionally, when the forklift assembly 1 is in operation, the control system 112 initiates movement of the forklift assembly 1. While moving, the plurality of sensors S distributed throughout the forklift assembly 1 become active. The sensors S may identify a level of the frame 2 and a slope of the extension assembly 6. When dealing with an uneven ground or surface, the sensors S may relay information to the control system, or direct the movement of the actuators of the extension assembly 6 to compensate for the terrain, or the positioning of the forklift assembly 1. In an embodiment, the forklift assembly may use a counterweight system to redistribute the weight when on an uneven surface, alternatively, the plurality of sensors S may permit reconfiguration of the forklift assembly 1 in order to redistribute a center of gravity and transfer weight distribution while navigating terrain. Additionally, the sensors S may provide conditional information of aspects of the system, and allow safe operation of the extension assembly, and/or control when it is possible for the forklift assembly 1 to be transitioned between a self-propelled mode of operation and a towed manner of operation, as discussed herein.

It should be noted that various changes and modifications to the embodiments described herein will be apparent to those skilled in the art. Such changes and modifications may be made without departing from the spirit and scope of the present invention and without diminishing its intended advantages. For example, various embodiments of the systems and methods may be provided based on various combinations of the features and functions from the subject matter provided herein.

What is claimed is:

1. A forklift assembly comprising:
a self-propelled frame having a pair of wheel assemblies, each providing a selectively driven wheel, the frame providing a carriage receiving assembly between the pair of wheel assemblies;
an extension assembly having a first end and a second end, the first end of the extension assembly being pivotably connected to the frame;
a control system; and
a carriage assembly having a prong assembly, the carriage assembly being operably connected to the second end of the extension assembly and configured to be controllably positioned within the carriage receiving assembly.

2. The forklift assembly of claim 1, wherein the self-propelled frame includes:
a front support assembly with a plurality of bracing plates positioned to form a rigid body, the bracing plates including a wheel support plate extending forwards from the rigid body; and at least one front wheel assembly supported by the wheel support plate, the at least one front wheel assembly having a selectively engageable drive system with a motor, a clutch assembly, a driveshaft having a first bearing surface and a second bearing surface and configured to be rotated by the motor, and a locking mechanism configured to selectively urge the driveshaft to shift in either a first direction or a second direction; and
a rear support assembly coupled to the front support assembly having a rear support frame; and
at least one rear wheel assembly; and
the extension assembly coupled to the rear support assembly and supporting the carriage assembly, wherein the carriage assembly is selectively engaged with the prong assembly.

3. The forklift assembly of claim 2, wherein the extension assembly further has:
a boom support;
a sliding support positioned within the boom support;
a sliding mechanism positioned within the sliding support;
a raising mechanism coupled to an outer edge of the boom support.

4. The forklift assembly of claim 2, wherein the carriage assembly further has:
a knuckle rotation assembly;
a carriage movement assembly positioned within the knuckle rotation assembly;
a back rest assembly coupled to the knuckle rotation assembly and the carriage movement assembly, and
wherein the prong assembly comprises a pair of prongs secured to the backrest assembly, and protruding forwards.

5. The forklift assembly of claim 2, the front support assembly further comprising a top plate and a bottom plate, with the bracing plates positioned therebetween.

6. The forklift assembly of claim 5, wherein the wheel support plate is provided with a first portion and a second portion, the first portion being perpendicularly positioned between the top plate and the bottom plate of the front support assembly, and the second portion extending forwards from the first portion, and not positioned in between the top plate and bottom plate.

7. The forklift assembly of claim 2, wherein the rear support assembly further comprises an articulating tow hitch is pivotably secured to the rear support frame.

8. The forklift assembly of claim 2, the at least one front wheel assembly comprises a pair of front wheel assemblies, each supported by a respective wheel support plate.

9. The forklift assembly of claim 2, wherein the locking mechanism provides a pushing member and an urging member.

10. The forklift assembly of claim 9, wherein the pushing member is configured to travel within a housing and is configured to reciprocate between a first position and a second position.

11. The forklift assembly of claim 10, wherein the urging member is in mechanical engagement with the pushing member, the urging member providing a collar with a plurality of radially oriented recesses, a plurality of plungers, and a plurality of biasing devices, with each recess of the plurality of recesses receiving one biasing device of the plurality of biasing devices, and one plunger of the plurality of plungers;
the plurality of plungers being oriented to be urged against a portion of the drive shaft.

12. The forklift assembly of claim 11, wherein the driveshaft is configured to be shifted laterally in a first direction in an amount for effecting engagement of the clutch assembly, and shifted laterally in a second direction in an amount for effecting the disengagement of the clutch assembly, the drive shaft further having an annular protrusion with the first bearing surface and the second bearing surface positioned on either side of an apex of the protrusion.

13. The forklift assembly of claim 12, where the lateral shifting of the drive shaft can be urged in the first direction by the positioning of the urging member such that the plurality of plungers are pressed against the first bearing surface of the pair of bearing surfaces, and the lateral shifting of the drive shaft can be urged in the second direction by the positioning of the urging member such that the plurality of plungers are pressed against the second bearing surface of the pair of bearing surfaces.

14. The forklift assembly of claim 13, the clutch assembly providing a driving clutch element mechanically fixed to the driveshaft, and a driven clutch element mechanically fixed to a wheel hub, the engagement of the clutch assembly is provided for powering the rotation of a wheel through the drive assembly by moving the driving clutch element into rotational interference with the driven clutch element.

15. The drive system of claim 14, wherein the drive system further comprises a motive power source, and the drive shaft has a power input end that engages the motive power source through a connection allowing relative lateral movement, and an output end that is mechanically fixed to the driving clutch element.

16. The drive system of claim 14, wherein the urging of the drive shaft in the first direction by the urging member will not be effective in laterally shifting the driveshaft until such a point as the clutch assembly is capable of being engaged.

17. The drive system of claim 14, wherein the urging of the drive shaft in the second direction by the urging member will not be effective in laterally shifting the driveshaft until such a point as the clutch assembly is capable of being disengaged.

18. The drive system of claim 12, wherein the reciprocating movement of the pushing member is directed by manipulating pressures in a first and second chamber alongside the pushing member, the pushing member having a medial seal that separates the first chamber from the second chamber.

19. A forklift assembly comprising a self-propelled frame having:
a pair of drive wheels;
an articulating tow hitch assembly with a tow hitch having a ball hitch receiver at a first end, and pivotably secured to the frame at a second end, with an actuator and linkage assembly configured for urging the pivoting movement of the tow hitch upon actuation of the actuator; and
a carriage assembly having a prong assembly, the carriage assembly mounted to an extension assembly configured to adjustably position the carriage assembly, and the carriage assembly and prong assembly configured to be positionable in a compact, stowed position characterized by the prongs being placed alongside the extension assembly and overlying and nearly parallel to a top surface of the frame.

20. The forklift assembly of claim 19, wherein the linkage assembly provides a swing arm pivotably secured to the frame and also pivotably secured to an extendible end of the tow hitch actuator.

21. The forklift assembly of claim 20, wherein the linkage assembly further comprises a linkage arm pivotably linking each of the swing arm and the second end of the tow hitch, such that extension of the tow hitch actuator will cause the first end of the tow hitch to be urged downwards relative to the frame, and retraction of the tow hitch actuator will cause the first end of the tow hitch to be urged upwards relative to the frame.

22. The forklift assembly of claim 21, wherein the linkage arm is a linear component, and the swing arm is a generally triangular component, with a pivoting mount to the frame at the top corner of the triangular swing arm, and the pivoting mount to each of the actuator and linkage arm are at the bottom of the triangle.

23. A forklift assembly comprising:
a self-propelled frame having a pair of drive wheels at a front end, and a rear wheel assembly at a rear end, and a carriage receiving assembly positioned between the drive wheels; and
a carriage assembly having a prong assembly, the carriage assembly positionable in the carriage receiving assembly such that the center of gravity of the of the forklift assembly, when the prong assembly is carrying a load, is maintained at a location between the drive wheels and the rear wheel assembly.

24. The forklift assembly of claim 23, further comprising a pair of counterbalance arms configured to be selectively positioned in a stowed position and a deployed position, where in a deployed position, the center of gravity of the forklift assembly is urged rearwards, relative to the center of gravity when the counterbalance arms are in a stowed position.
